(19) United States
(12) Patent Application Publication
(10) Pub. No.: US 2025/0008489 A1
(43) Pub. Date: Jan. 2, 2025

(54) METHOD FOR RESOURCE RESELECTION AND DEVICE

(71) Applicant: GUANGDONG OPPO MOBILE TELECOMMUNICATIONS CORP., LTD., Dongguan (CN)

(72) Inventor: Yi DING, Dongguan (CN)

(21) Appl. No.: 18/883,729

(22) Filed: Sep. 12, 2024

Related U.S. Application Data
(63) Continuation of application No. PCT/CN2022/082184, filed on Mar. 22, 2022.

(51) Int. Cl. H04W 72/02; H04B 17/318; H04W 72/25; H04W 72/40; H04W 72/566

(52) U.S. Cl. CPC H04W 72/02; H04B 17/328; H04W 72/25; H04W 72/40; H04W 72/566

(57) ABSTRACT

Provided is a method for resource reselection. The method is applicable to a terminal device and includes: reselecting a first resource in a case that the first resource meets a first condition. The first condition includes at least one of the following items: the first resource is not within a first resource set, wherein the first resource set is determined based on first sidelink control information and second sidelink control information; a second resource determined based on the first resource is overlapped with a resource determined based on first sidelink control information or second sidelink control information, and a reference signal received power (RSRP) threshold condition is met; or a priority indicated by first sidelink control information or second sidelink control information is higher than a priority of data transmission and/or higher than a priority threshold. The first sidelink control information is different from the second sidelink control information.

### CROSS-REFERENCE TO RELATED APPLICATION

This application is a continuation application of international application No. PCT/CN2022/082184, filed on Mar. 22, 2022, the entire contents of which are incorporated herein by reference.

### TECHNICAL FIELD

Embodiments of the present disclosure relate to the technical field of communications, and in particular, relate to a method and apparatus for resource reselection, and a device, a storage medium, and a program product.

### BACKGROUND

In sidelink (SL) communication, a terminal device may select transmission resources from a resource pool by monitoring. Currently, further research is required on a method for resource selection and reselection in a new radio (NR) system.

### SUMMARY

Embodiments of the present disclosure provide a method and apparatus for resource reselection, and a device, a storage medium and a program product. The technical solutions are as follows.

According to some embodiments of the present disclosure, a method for resource reselection is provided. The method is applicable to a terminal device, and the method includes:
reselecting a first resource in a case that the first resource meets a first condition; wherein
the first condition includes at least one of the following items:
the first resource is not within a first resource set, wherein the first resource set is determined based on first sidelink control information and second sidelink control information;
a second resource determined based on the first resource is overlapped with a resource determined based on first sidelink control information or second sidelink control information, and a reference signal received power (RSRP) threshold condition is met; or
a priority indicated by first sidelink control information or second sidelink control information is higher than a priority of data transmission and/or higher than a priority threshold,
wherein the first sidelink control information is different from the second sidelink control information.

According to some embodiments of the present disclosure, a terminal device is provided. The terminal device includes a processor and a memory storing one or more computer programs, wherein the processor, when loading and running the one or more computer programs, is caused to perform the method for resource reselection described above.

### BRIEF DESCRIPTION OF THE DRAWINGS

FIG. 1 is a schematic diagram of a network architecture according to some embodiments of the present disclosure;

FIG. 2 is a schematic diagram illustrating two transmission modes according to some embodiments of the present disclosure;

FIG. 3 is a schematic diagram of the NR V2X physical layer structure according to some embodiments of the present disclosure;

FIG. 4 is a schematic diagram of the time-frequency resource location reservation according to some embodiments of the present disclosure;

FIG. 5 is a schematic diagram of resource monitoring and resource selection according to some embodiments of the present disclosure;

FIG. 6 is a schematic diagram of the LTE V2X according to some embodiments of the present disclosure;

FIG. 7 is a schematic diagram of a resource re-evaluation mechanism according to some embodiments of the present disclosure;

FIG. 8 is a schematic diagram of a resource pre-emption mechanism according to some embodiments of the present disclosure;

FIG. 9 is a flowchart of a method for resource reselection according to some embodiments of the present disclosure;

FIG. 10 is a flowchart of a method for resource reselection according to some other embodiments of the present disclosure;

FIG. 11 is a flowchart of a method for resource reselection according to some other embodiments of the present disclosure;

FIG. 12 is a schematic diagram of a resource pre-emption mechanism according to some other embodiments of the present disclosure;

FIG. 13 is a flowchart of a method for resource reselection according to some other embodiments of the present disclosure;

FIG. 14 is a block diagram of an apparatus for resource reselection according to some embodiments of the present disclosure; and

FIG. 15 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail below with reference to the accompanying drawings.

The network architecture and service scenarios described in the embodiments of the present disclosure are intended to describe the technical solutions according to the embodiments of the present disclosure more clearly, but do not constitute any limitation on the technical solutions according to the embodiments of the present disclosure. Those of ordinary skilled in the art understand that, with the evolution of the network architecture and the emergence of new service scenarios, the technical solutions according to the embodiments of the present disclosure are also applicable to similar technical problems.

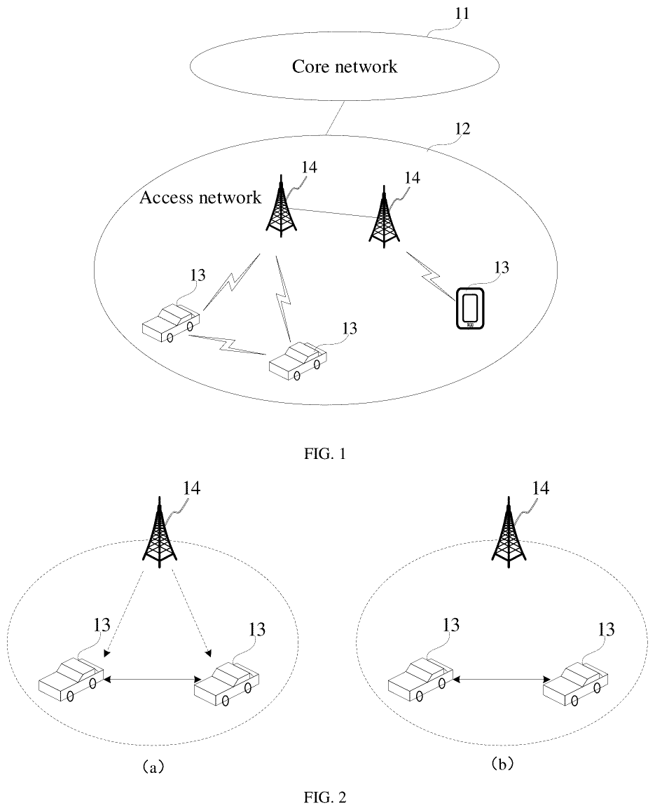

Referring to FIG. 1, a schematic diagram of a network architecture according to some embodiments of the present disclosure is shown. The network architecture includes: a core network 11, an access network 12, and terminal devices 13.

The core network 11 includes a plurality of core network devices. The core network devices mainly function to provide user connection, user management, and service bearing, and serve as a bearer network to provide an interface to an external network. For example, the core network of a 5^{th} generation (5G) NR system may include devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionality for the terminal devices 13. The access network device 14 may include various forms of macro base stations, micro base stations, relay stations, access points, and the like. The name of the device with the functionality of an access network device may vary in systems employing different radio access technologies. For example, the device is referred to as gNodeB or gNB in the 5G NR system. With the evolution of communication technologies, the name “access network device” may change. For the convenience of description, in the embodiments of the present disclosure, the above apparatuses providing the wireless communication functionality for the terminal devices 13 are collectively referred to as the access network devices.

Typically, a plurality of terminal devices 13 are provided, and one or more terminal devices 13 may be distributed in a cell managed by each of the access network devices 14. The terminal devices 13 may include various handheld devices, vehicle-mounted devices, wearable devices, computing devices, or other processing devices connected to a radio modem with the wireless communication functionality, as well as various forms of user equipments, mobile stations (MS), and the like. For convenience of description, the devices described above are collectively referred to as the terminal devices. The access network devices 14 communicate with the core network devices using some air technology, such as an NG interface in the 5G NR system. The access network devices 14 communicate with the terminal devices 13 using some air technology, such as a Uu interface.

The terminal devices 13 (for example, the vehicle-mounted device and another device, such as another vehicle-mounted device, a mobile phone, or a road side unit (RSU)) may communicate with each other over a direct communication interface (for example, a PC5 interface). Accordingly, the communication link established based on the direct communication interface may be referred to as a direct link or SL. The SL transmission means that communication data transmission is carried out directly between the terminal devices over a sidelink, which is different from a conventional cellular system in which the communication data is received or transmitted by access network devices. The SL transmission has characteristics of short delay and low overhead, and is therefore suitable for communication between two terminal devices that are geographically close to each other, such as a vehicle-mounted device and another peripheral device that is geographically close to the vehicle-mounted device. It should be noted that, in FIG. 1, only vehicle-to-vehicle communication in a vehicle to everything (V2X) scenario is taken as an example, while the SL technology is applicable to various scenarios in which terminal devices directly communicate with each other. In other words, the terminal device in the present disclosure refers to any device that communicates using the SL technology.

The “5G NR system” in the embodiments of the present disclosure may also be referred to as a 5G system or an NR system, but those skilled in the art can understand the meaning thereof. The technical solutions described in the embodiments of the present disclosure are applicable to the 5G NR system, and also to evolved systems of the 5G NR system. In the embodiments of the present disclosure, “terminal device” and “UE” generally convey the same meaning and may be used interchangeably, and those skilled in the art can understand their meanings.

Before the technical solutions of the present disclosure are detailed, some background technical knowledge involved in the present disclosure is first explained. Alternatively, the following related technologies may be combined with the technical solutions of the embodiments of the present disclosure in any manner, all of which fall within the protection scope of the embodiments of the present disclosure. The embodiments of the present disclosure include at least some of the following.
1. SL Transmission

Device-to-device communication is a sidelink transmission technology, which differs from the traditional cellular system where communication data is received or transmitted via a base station. For example, in the V2X system, device-to-device direct communication is also used, thus providing higher spectrum efficiency and lower transmission delay. Regarding device-to-device communication, 3GPP has defined two transmission modes: a mode A and a mode B.

In the mode A, as shown in FIG. 2(a), transmission resources of terminal devices 13 are allocated by an access network device 14 (such as a base station). Terminal devices 13 transmit communication data on the sidelink based on the transmission resources allocated by the access network device 14. The access network device 14 may allocate transmission resources to terminal devices 13 for single transmission, or allocate transmission resources to terminal devices 13 for semi-static transmission.

In the mode B, as shown in FIG. 2(b), terminal devices 13 select transmission resources from a resource pool autonomously for the transmission of communication data. Specifically, terminal devices 13 may select transmission resources from the resource pool either by monitoring or by random selection.

Next, SL communication in NR V2X systems and long-term evolution (LTE) V2X, wherein terminal devices autonomously select resources (i.e., the mode B described above) will be mainly described.
2. NR V2X Physical Layer Structure

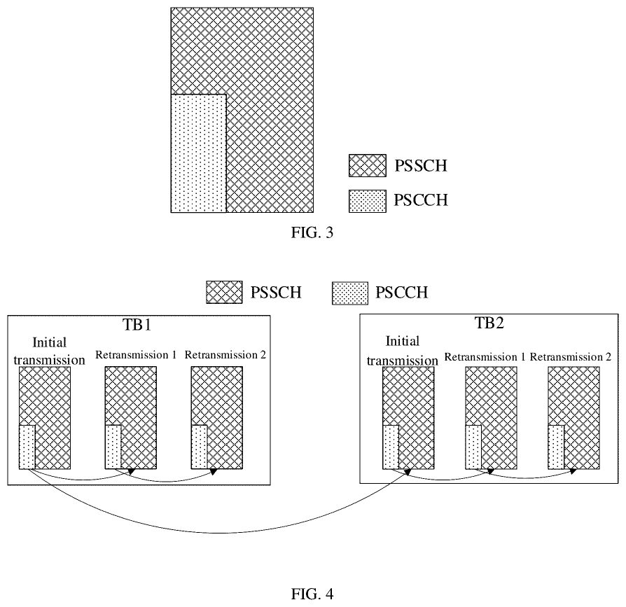

A physical layer structure of SL communication in the NR V2X system is shown in FIG. 3. The physical sidelink control channel (PSCCH) is configured to bear the first sidelink control information, and the physical sidelink shared channel (PSSCH) is configured to bear data and the third sidelink control information. The PSCCH and PSSCH are transmitted in the same slot. The first sidelink control information and third sidelink control information may be two types of sidelink control information serving different purposes. For example, the first sidelink control information is carried in the PSCCH and mainly includes fields related to resource monitoring, facilitating other terminal devices to perform resource exclusion and resource selection upon decoding. In the PSSCH, the third sidelink control information is further carried in addition to data, wherein the third sidelink control information mainly includes fields related to data demodulation, facilitating other terminal devices to demodulate the data in the PSSCH.

Exemplarily, the first sidelink control information is the 1st-stage-SCI, i.e., the first-stage sidelink control information (SCI).

Exemplarily, the third sidelink control information is the 2nd-stage-SCI, i.e., the second-stage SCI.
3. Resource Reservation in NR V2X

In the NR V2X system, in the mode B described above, the terminal devices select transmission resources autonomously for data transmission. Resource reservation is a prerequisite for resource selection.

The resource reservation means that the terminal device transmits the first sidelink control information in the PSCCH to reserve resources to be used next. In the NR V2X system, intra-transport block (TB) resource reservation is supported, and inter-TB resource reservation is supported as well.

As shown in FIG. 4, the terminal device transmits the first sidelink control information, and indicates N time-frequency resources (including a resource used for current transmission) of a current TB by using the “Time resource assignment” and “Frequency resource assignment” fields in the first sidelink control information. N≤Nmax, and Nmax is equal to 2 or 3 in NR V2X. Further, the indicated N time-frequency resources should be distributed in W slots. W is equal to 32 in NR V2X. For example, in a TB1 as shown in FIG. 4, the terminal device transmits the first sidelink control information in the PSCCH while transmitting initial transmission data in the PSSCH, and indicates time-frequency resource locations for initial transmission and retransmission 1 (i.e., N=2 in this case) by using the two fields described above, i.e., to reserve a time-frequency resource for retransmission 1. Moreover, initial transmission and retransmission 1 are distributed in 32 slots in a time domain. Similarly, in the TB1 as shown in FIG. 4, the terminal device indicates time-frequency resource locations for retransmission 1 and retransmission 2 using the first sidelink control information transmitted in the PSCCH of retransmission 1, and retransmission 1 and retransmission 2 are distributed in 32 slots in the time domain.

Besides, in transmitting the first sidelink control information, the terminal device performs the inter-TB resource reservation by using a “Resource reservation period” field. For example, in FIG. 4, in transmitting the first sidelink control information of initial transmission of the TB1, the terminal device indicates time-frequency resource locations for initial transmission and retransmission 1 of the TB1 by using the “time resource assignment” and “Frequency resource assignment” fields, which are denoted as {(t₁, f₁), (t₂, f₂)}, wherein t₁ and t₂ represent time domain locations of initial transmission and retransmission 1 resources of the TB1, and f₁ and f₂ represent corresponding frequency domain locations. In the case that a value of the “Resource reservation period” field in the first sidelink control information is 100 ms, the SCI simultaneously indicates the time-frequency resources {(t₁+100, f₁), (t₁+100, f₂)}. These two resources are used for the initial transmission and the retransmission 1 of TB2. Similarly, the first sidelink control information transmitted in retransmission 1 of the TB1 also reserves time-frequency resources for retransmission 1 and retransmission 2 of the TB2 by using the “resource reservation period” field. In NR V2X, the possible values for the “Resource reservation period” field are 0, 1-99, 100, 200, 300, 400, 500, 600, 700, 800, 900, and 1000 ms, offering greater flexibility compared to LTE V2X. However, only e values are configured in each resource pool, and the terminal device determines a possible value to be used based on the used resource pool. The e values in the resource pool configuration are denoted as a resource reservation period set M, and exemplarily, e is less than or equal to 16.

In addition, the above inter-TB reservation may be activated or deactivated on a resource pool basis by means of network configuration or preconfiguration. In the case that the inter-TB reservation is activated, the first sidelink control information includes the “Resource reservation period” field. In the case that the inter-TB reservation is deactivated, the first sidelink control information does not include the “Resource reservation period” field. In the case that the inter-TB reservation is activated, the value of the “Resource reservation period” field used by the terminal device, i.e., the resource reservation period, is generally not changed prior to triggering resource reselection. The terminal device reserves resources for a next period by using the “Resource reservation period” field in the first sidelink control information for transmission of another TB every time the terminal device transmits the first sidelink control information, such that periodic semi-persistent transmission is achieved.

In the case that the terminal device operates in the mode B described above, the terminal device may acquire the first sidelink control information transmitted by other terminal devices by monitoring the PSCCHs from the other terminal devices, such that the resources reserved by the other terminal devices are acknowledged. In resource selection, the terminal device may exclude the resources reserved by the other terminal devices, such that resource collision is avoided.
4. Resource Selection Method for NR V2X Monitoring

In the NR V2X system, in the mode B described above, the terminal device needs to select resources autonomously.

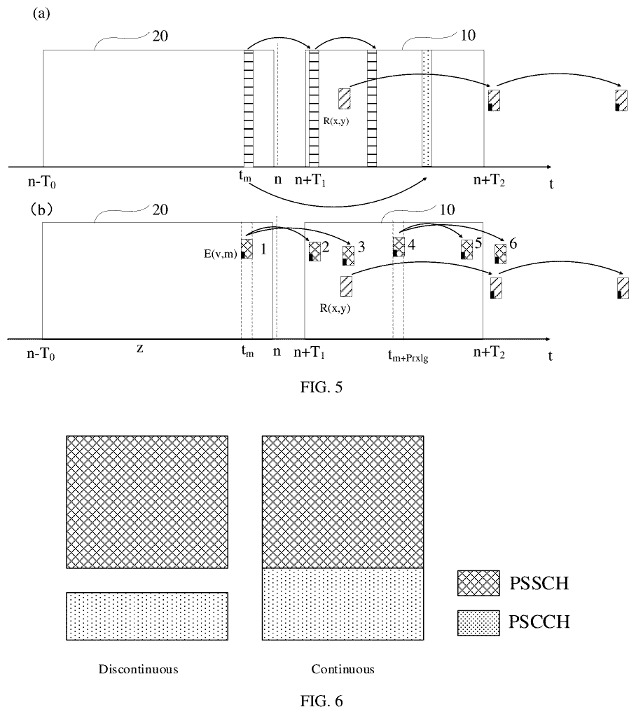

As shown in FIG. 5, the terminal device triggers resource selection or reselection in a slot n, or the slot n is a slot where a higher layer triggers a physical layer to report a candidate resource set, and a resource selection window 10 starts from n+T₁ and ends at n+T₂. 0≤T₁≤T_{proc,1}, and in the case that the subcarrier spacing is 15, 30, 60, or 120 kHz, T_{proc,1} is 3, 5, 9, or 17 slots. T₂ₘᵢₙ≤T₂≤a remaining delay budget of service, wherein a value set of T₂ₘᵢₙ is {1, 5, 10, 20}*2^{μ} slots, wherein μ=0, 1, 2, or 3, which correspond to the subcarrier spacing being 15, 30, 60, or 120 kHz, respectively. The terminal device determines T₂ₘᵢₙ from the value set based on a priority of its own to-be-transmitted data. For example, in the case that the subcarrier spacing is 15 kHz, the terminal device determines T₂ₘᵢₙ from the set {1, 5, 10, 20} based on the priority of its own to-be-transmitted data. In the case that T₂ₘᵢₙ is greater than or equal to the remaining delay budget of service, T₂ is equal to the remaining delay budget of service. The remaining delay budget means a difference between a corresponding time of a delay requirement of the data and a current time. For example, for a packet arriving in the slot n, the delay requirement is 50 ms, and assuming that one slot is 1 ms, the remaining delay budget is 50 ms in the case that the current time is the slot n, and the remaining delay budget is 30 ms in the case that the current time is a slot n+20.

The terminal device monitors resources from n-T₀ to n-T_{proc,0} (excluding n-T_{proc,0}), and a value of T₀ is 100 or 1100 ms. In the case that the subcarrier spacing is 15, 30, 60, or 120 kHz, T_{proc,0}is 1, 1, 2, or 4 slots. In some embodiments, the terminal device monitors resources in a slot that is within a resource pool used by the terminal device within a resource sensing window. In some embodiments, the terminal device monitors the first sidelink control information transmitted by other terminal devices in each slot (except for its own transmission slot), and upon resource selection or reselection is triggered in the slot n, the terminal device uses the results of resource monitoring in n-T₀ to n-T_{proc,0}.

In step 1, the terminal device regards all available resources that are within the resource pool used by the terminal device in the resource selection window 10 as a resource set A, and any of the resources in the set A is denoted as R(x, y), wherein x and y respectively indicate a frequency domain location and a time domain location of the resource. An initial number of the resources in the set A is denoted as Mₜₒₜₐₗ. The terminal device performs exclusion on the resources in the resource set A based on a non-monitored slot in the resource sensing window 20 (step 1-1) and/or resource monitoring results in the resource sensing window 20 (step 1-2). The terminal device determines whether the resource R(x, y) or a series of periodic resources corresponding to the resource R(x, y) overlaps with a slot determined based on the non-monitored slot in step 1-1 or a resource determined based on the monitored first sidelink control information in step 1-2, and excludes the resource R(x, y) from the resource set A in the case that they overlap.

In step 1-1, in the case that the terminal device transmits data in the slot tₘ within the resource sensing window 20 and does not perform monitoring, the terminal device determines corresponding Q slots based on the slot tₘ and each allowed resource reservation period in the resource pool used by the terminal device, with the resource reservation period as an interval. In the case that the Q slots overlap with the resource R(x, y) or the series of periodic resources corresponding to the resource R(x, y), the resource R(x, y) is excluded from the resource set A. Q=1 or Q=[T_{sca}l/Prx] (for rounding up). Tscal is equal to a converted value of T₂ into milliseconds. Prx is one of the resource reservation periods allowed by the resource pool used by the terminal device. In some embodiments, a series of periodic resources corresponding to the resource R(x, y) are a series of periodic resources mapped at certain time gap with the same frequency domain resources occupied by R(x, y), as shown in subfigure (a) of FIG. 5 and subfigure (b) of FIG. 5. For example, the time gap is the resource reservation period of the terminal device itself. Moreover, the series of periodic resources corresponding to the resource R(x, y) include the resource R(x, y).

For example, in subfigure (a) of FIG. 5, the terminal device does not perform monitoring in the slot tₘ, and performs resource exclusion in sequence based on each resource reservation period in the resource reservation period set M in the used resource pool configuration. For a certain resource reservation period 1, assuming that the Q value is calculated to be 2, the corresponding Q slots are two next slots mapped from the slot tₘ in subfigure (a) of FIG. 5 as indicated by horizontal line shadow, with the resource reservation period 1 as an interval. In the case that the 2 slots indicated by horizontal line shadow overlap with the resource R(x, y) or the series of periodic resources corresponding to the resource R(x, y), the resource R(x, y) is excluded from the resource set A. For a certain resource reservation period 2, assuming that the Q value is calculated to be Q=1, the corresponding Q slots are one next slot mapped from the slot tₘ in subfigure (a) of FIG. 5 as indicated by dotted shadow, with the resource reservation period 2 as an interval. In the case that the slots indicated by dotted shadow overlap with the resource R(x, y) or the series of periodic resources corresponding to the resource R(x, y), the resource R(x, y) is excluded from the resource set A.

The terminal device determines whether Q slots corresponding to each reservation period overlap with the resource R(x, y) or the series of periodic resources corresponding to the resource R(x, y), and excludes the resource R(x, y) from the resource set A in the case that they overlap.

In some embodiments, in the case that the inter-TB reservation is deactivated for the resource pool used by the terminal device, the terminal device does not perform step 1-1 above.

In some embodiments, upon completion of step 1-1, in the case that the remaining resources in the resource set A are less than Mₜₒₜₐₗ*X, the resource set A is initialized into all available resources within the resource pool used by the terminal device in the resource selection window 10, and then step 1-2 is performed.

In step 1-2, in the case that the terminal device monitors the first sidelink control information transmitted in the PSCCH within the slot tₘ of the resource sensing window 20, the sidelink reference signal received power (SL-RSRP) of the PSCCH or the SL-RSRP of the PSSCH scheduled by the PSCCH (i.e., the SL-RSRP of the PSCCH transmitted in the same slot as the PSCCH) is measured.

In the case that the measured SL-RSRP is greater than the SL-RSRP threshold and the first sidelink control information monitored by the terminal device includes the “Resource reservation period” field, the terminal device determines the corresponding Q slots based on the slot tₘ and the resource reservation period carried in the monitored first sidelink control information, with the resource reservation period as an interval. The terminal device assumes that the first sidelink control information with the same content is received in the Q slots as well. The terminal device determines whether the resources indicated by the “Time resource assignment” and “Frequency resource assignment” fields of the first sidelink control information received in the slot tₘ and the Q pieces of the first sidelink control information assumed to be received overlap with the resource R(x, y) or the series of periodic resources corresponding to the resource R(x, y), and excludes the corresponding resource R(x, y) from the set A in the case that they overlap. The above Q=1 or Q=[Tscal/Prx] (for rounding up). Tscal is equal to a converted value of T₂ into milliseconds. Prx is the resource reservation period carried in the monitored first sidelink control information.

For example, in subfigure (b) of FIG. 5, in the case that the terminal device monitors the first sidelink control information in the PSCCH in the slot tₘ, and the first sidelink control information includes the “Resource reservation period” field, with the resource reservation period indicated by the field being Prx, and assuming that the Q value is calculated as 1, the terminal device assumes that the first sidelink control information with the same content is also received at the next slot with Prx as the interval and slot tₘ as the starting point (i.e., the slot where resource 4 is located). The terminal device determines whether the resources 1, 2, 3, 4, 5, and 6 indicated by the “Time resource assignment” and “Frequency resource assignment” fields of the first sidelink control information received in the slot tₘ and the first sidelink control information assumed to be received overlap with the resource R(x, y) or the series of periodic resources corresponding to the resource R(x, y), and excludes the resource R(x, y) from the resource set A in the case that they overlap and the RSRP condition is satisfied.

In the case that the SL-RSRP measured by the terminal device is greater than the SL-RSRP threshold and the first sidelink control information monitored by the terminal device does not include the “Resource reservation period” field, the terminal device only determines whether the resource indicated by the “Time resource assignment” and “Frequency resource assignment” fields of the first sidelink control information received in the slot tₘ overlaps with the resource R(x, y) or the series of resources corresponding to the resource R(x, y), and excludes the resource R(x, y) from the resource set A in the case that they overlap.

For example, in subfigure (b) of FIG. 5, in the case that the terminal device monitors the first sidelink control information in the PSCCH in the slot tₘ, and the first sidelink control information does not include the “Resource reservation period” field, the terminal device determines whether the resources 1, 2, and 3 indicated by the “Time resource assignment” and “Frequency resource assignment” fields in the first sidelink control information overlap with the resource R(x, y) or the series of periodic resources corresponding to the resource R(x, y), and excludes the resource R(x, y) from the resource set A in the case that they overlap and the RSRP condition is satisfied.

In the case that the number of the remaining resources in the resource set A upon the above resource exclusion are less than Mₜₒₜₐₗ*X, the SL-RSRP threshold is raised by 3 dB, and step 1 is performed again. The physical layer reports the resource set A upon resource exclusion to a higher layer as a candidate resource set.

In step 2, the higher layer randomly selects resources from the reported candidate resource set for data transmission. That is, the terminal device randomly selects resources from the candidate resource set for data transmission.

It should be noted that:
1. The above RSRP threshold is determined based on the priority P1 carried in the PSCCH monitored by the terminal device and the priority P2 of the data to be transmitted by the terminal device. The configuration of the resource pool used by the terminal device includes an SL-RSRP threshold table, and the SL-RSRP threshold table includes SL-RSRP thresholds corresponding to all priority combinations. The configuration of the resource pool may be configured on the network or preconfigured.

For example, as listed in Table 1, it is assumed that the selectable values of the priority levels of both P1 and P2 are 0 to 7, the SL-RSRP thresholds corresponding to different priority combinations are represented by γij, wherein in γij, i is a value of the priority level P1, and j is a value of the priority level P2.

TABLE 1
SL-RSRP threshold table

P2

| P1 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

In the case that the terminal device monitors the PSCCH transmitted by another terminal device, the terminal device acquires a priority P1 carried in the first sidelink control information transmitted in the PSCCH and a priority P2 of the to-be-transmitted data, and the terminal device determines an SL-RSRP threshold by looking up in Table 1.
2. Whether the terminal device compares the measured PSCCH-RSRP or a PSSCH-RSRP scheduled by the PSCCH with the SL-RSRP threshold depends on the resource pool configuration of the resource pool used by the terminal device. The resource pool configuration may be configured on the network or preconfigured.
3. The value of X described above is possibly {20%, 35%, 50%}. The configuration of the resource pool used by the terminal device includes correspondence between the priorities and the possible values described above, and the terminal device determines the value of X based on the priority of the to-be-transmitted data and the correspondence. The resource pool configuration may be configured on the network or preconfigured.
4. The resource reservation period is converted into logical slots.

As mentioned above, the terminal device transmits the first sidelink control information to indicate time-frequency resources to reserve resources to be used next. In monitoring, the terminal device for resource selection decodes the first sidelink control information transmitted by other terminal devices to acquire resources reserved by the other terminal devices, and then excludes the corresponding resources during resource selection, such that resource collision is avoided. In resource exclusion, the terminal device for resource selection converts a physical time (for example, 100 ms) indicated by the “resource reservation period” field in the decoded first sidelink control information into a corresponding number of logical slots, and then performs resource exclusion by using the number of the logical slots:

$${P}_{rsvp}^{′} = ⌈ \frac{{T}_{max}^{′}}{10240 ms} \times {P}_{rsvp} ⌉$$

In the above formula, Prsvp represents a resource reservation period, for example, a resource reservation period indicated by the “resource reservation period” in the first sidelink control information monitored by the terminal device, or a resource reservation period allowed in the resource pool, or a resource reservation period of the terminal device, and P′rsvp represents a calculated number of corresponding logical slots. T′max represents a number of slots within a resource pool or a transmission resource pool of the terminal device in a system frame number (SFN) period or in 10240 ms.

The above description is for the SL communication method in NR-V2X, i.e., the terminal device independently selects transmission resources by resource monitoring and performs data transmission on the sidelink autonomously. The SL communication method is applicable to various SL communications such as direct communication between handheld terminals and direct communication between pedestrians and vehicles.
5. LTE V2X Physical Layer Structure

The physical layer structure of SL communication in the LTE V2X system is shown in FIG. 6. The PSCCH is configured to bear the second sidelink control information, and the PSSCH is configured to bear data. The PSCCH and PSSCH are transmitted in the same subframe. In LTE V2X, the PSCCH and PSSCH may be either continuous or discontinuous in the frequency domain.

The second sidelink control information is carried in the PSCCH and mainly includes fields related to resource monitoring, which facilitate other terminal devices to perform resource exclusion and resource selection upon decoding.

In addition, methods for resource reservation and monitoring-based resource selection in the LTE V2X system are similar to those in the NR V2X system, which will not be elaborated on in the present disclosure. Here are just some brief introductions: In the LTE V2X system, the first to third information fields in the second sidelink control information are used to indicate the retransmission resources within the same TB. In some embodiments, the fourth information field in the second sidelink control information is further used to indicate the transmission resources of another TB. The first information field refers to the “Frequency resource location of the initial transmission and retransmission” in the second sidelink control information, the second information field refers to the “Time gap between initial transmission and retransmission” in the second sidelink control information, the third information field refers to the “Retransmission index” in the second sidelink control information, and the fourth information field refers to the “Resource reservation” in the second sidelink control information.
6. Re-evaluation and Pre-emption Mechanisms in NR V2X

In NR-V2X, upon completion of the resource selection, it also supports the re-evaluation of the resources that have been selected but not indicated by transmitting the first sidelink control information.

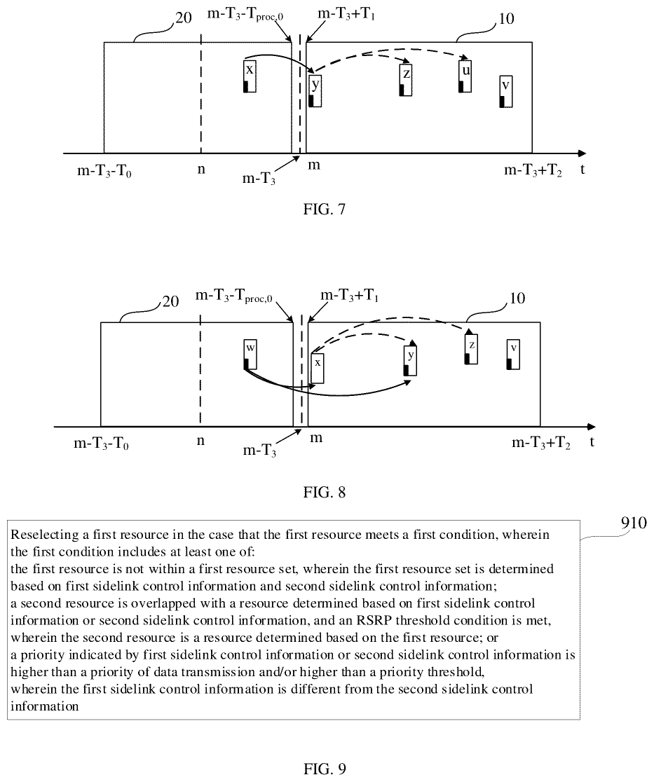

As shown in FIG. 7, resources x, y, z, u, and v are time-frequency resources that have been selected by the terminal device in slot n, and resource y is located in slot m. For the resources z and u, which the terminal device is about to indicate for the first time by transmitting the first sidelink control information in the resource y (the resource y has been previously indicated by the first sidelink control information in the resource x), the terminal device performs the step 1described above at least once in slot m-T₃. That is, at least in slot m-T₃, the terminal device determines the resource selection window 10 and the resource sensing window 20 as described above, and performs step 1 to exclude resources within the resource selection window 10 to obtain a candidate resource set. In the case that the resources z and/or u are not in the candidate resource set, the terminal device performs the step 2 to reselect the time-frequency resource from the resources z and u that is not in the candidate resource set. Depending on practice of the terminal device, the terminal device may also reselect any resource that has already been selected but not indicated by transmitting the first sidelink control information, such as any one or more of the resources z, u, and v. T₃ is equal to T_{proc,1}. In FIG. 7, the dashed arrow indicates that the first sidelink control information indication is to be transmitted, and the solid arrow indicates that the first sidelink control information indication has already been transmitted.

In addition, NR-V2X also supports a resource pre-emption mechanism. In NR-V2X, conclusions about the resource pre-emption mechanism are described from the perspective of a terminal whose selected resources are preempted. Upon completion of resource selection, the terminal device continuously monitors the first sidelink control information. In the case that a resource that has been selected and has been indicated by transmitting the first sidelink control information meets the following three conditions, it indicates that the resource has been pre-empted by another terminal device, and the terminal device triggers resource reselection for the resource:
1. The resource that have been selected and indicated by the terminal device is not in the candidate resource set.
2. The resource indicated in the monitored first sidelink control information overlaps with the resource that have been selected and indicated by the terminal device, and the SL-RSRP of the PSCCH corresponding to the monitored first sidelink control information or the SL-RSRP of the PSSCH scheduled by the PSCCH is greater than the SL RSRP threshold.
3. The priority carried in the monitored first sidelink control information is higher than the priority of the data to be transmitted by the terminal device. Alternatively, the priority carried in the monitored first sidelink control information is higher than the priority of the data to be transmitted by the terminal device, and the priority carried in the monitored first sidelink control information is higher than the threshold U, wherein U depends on the resource pool configuration, and the resource pool may be configured on the network or pre-configured.

As shown in FIG. 8, resources w, x, y, z, and v are time-frequency resources that have already been selected by the terminal device in slot n, and resource x is located in slot m. For the resources x and y, which the terminal device is about to indicate by transmitting the first sidelink control information on resource x and have already been indicated by the first sidelink control information previously transmitted by the terminal device, the terminal device performs the step 1 at least once in slot m-T₃. That is, the terminal device determines the resource selection window 10 and the resource sensing window 20 at least in slot m-T₃ as described above, and performs the step 1 to exclude the available resources within the resource selection window 10 to determine a candidate resource set. In the case that the resources x and/or y meet the aforementioned three conditions, the terminal device performs step 2 to reselect the time-frequency resource from the resources x and y that meets the aforementioned three conditions. In addition, in the case that resource reselection is triggered, depending on the practice of the terminal device, the terminal device may reselect any resource that has already been selected but not indicated by transmitting the first sidelink control information, such as any one or more of the resources z and v. T₃ is equal to T_{proc,0}.

Currently, one of the research projects under the R18 sidelink standard is the coexistence of LTE sidelink (referred to as LTE SL) and NR sidelink (referred to as NR SL) on overlapping frequency bands. In the case that LTE SL UEs and NR SL UEs use overlapping resource pools, the standard for avoiding resource collisions between them has not yet been discussed. On the one hand, LTE SL UEs do not decode the sidelink control information of NR SL UEs, and therefore cannot acquire the resource reservation information of NR SL UEs, making it impossible to avoid resource collisions with NR SL UEs. On the other hand, NR SL UEs may include both LTE SL and NR SL modules, allowing them to decode the sidelink control information of both LTE SL UEs and NR SL UEs. In this case, resource collisions with both LTE SL UEs and NR SL UEs are avoided.

From the above description, it can be understood that NR SL supports the re-evaluation mechanism and the pre-emption mechanism. In the case that NR SL and LTE SL are deployed on overlapping frequency bands, further research is needed on how NR SL UEs re-evaluate the selected resources based on the sidelink control information received from LTE SL UEs and NR SL UEs, and how to determine whether the selected resources have been pre-empted based on the sidelink control information received from LTE SL UEs and NR SL UEs.

The technical solutions of the present disclosure will be described below with reference to several exemplary embodiments.

Referring to FIG. 9, a flowchart of a method for resource reselection according to some embodiments of the present disclosure is shown. The method is applicable to the network architecture as shown in FIG. 1. For example, the method may be applicable to a terminal device. The method includes the following processes.

In process 910, a first resource is reselected in the case that the first resource meets a first condition.

The first condition includes at least one of the following items:
the first resource is not within a first resource set, where the first resource set is determined based on first sidelink control information and second sidelink control information;
the second resource determined based on the first resource is overlapped with the resource determined based on first sidelink control information or second sidelink control information, and a RSRP threshold condition is met; or
the priority indicated by first sidelink control information or second sidelink control information is higher than the priority of data transmission and/or higher than the priority threshold.

The first sidelink control information is different from the second sidelink control information.

For case of description, in the present disclosure, unless otherwise specified, “the first resource not being within the first resource set” is denoted as “condition 1”; “the second resource being overlapped with the resource determined based on the first sidelink control information or the second sidelink control information, and the RSRP threshold condition being met” is denoted as “condition 2”; “the priority indicated by the first sidelink control information or the second sidelink control information being higher than the priority of data transmission and/or higher than the priority threshold” is denoted as “condition 3”. That is, the first condition includes at least one of the condition 1, condition 2, or condition 3.

In some embodiments, the first sidelink control information and the second sidelink control information are sidelink control information from two different communication systems. In some embodiments, the first sidelink control information is sidelink control information from a first communication system, the second sidelink control information is sidelink control information from a second communication system, and the first communication system is different from the second communication system. Exemplarily, the first sidelink control information is sidelink control information from an NR system, and the second sidelink control information is sidelink control information from an LTE system or an evolved universal terrestrial radio access (E-UTRA) system. It should be noted that this is merely an exemplary illustration where the first communication system is an NR system and the second communication system is an LTE system or an E-UTRA system. The present disclosure does not limit the first communication system and the second communication system to these combinations, and other combinations are also possible.

In some embodiments, the first sidelink control information and the second sidelink control information are sidelink control information with different functions. In some embodiments, the first sidelink control information has a first function, the second sidelink control information has a second function, and the first function is different from the second function. Exemplarily, the first sidelink control information is configured to schedule PSSCH and the third sidelink control information, and the second sidelink control information is configured to schedule PSSCH. The third sidelink control information is carried in the PSSCH and mainly includes fields related to data demodulation, facilitating other terminal devices to demodulate the data in the PSSCH. In some embodiments, the third sidelink control information is the 2nd-stage-SCI, i.e., second-stage SCI. It should be noted that this is merely an exemplary illustration where the first function is a function to schedule PSSCH and the third sidelink control information, and the second function is a function to schedule PSSCH. The present disclosure does not limit the first function and the second function to these combinations, and other combinations are also possible.

In some embodiments, the first sidelink control information and the second sidelink control information are sidelink control information with different formats. In some embodiments, the first sidelink control information has a first format, the second sidelink control information has a second format, and the first format is different from the second format. Exemplarily, the first sidelink control information has the format of SCI format 1-A, and the second sidelink control information has the format of SCI format 1. It should be noted that this is merely an exemplary illustration where the first format is SCI format 1-A and the second format is SCI format 1. The present disclosure does not limit the first format and the second format to these combinations, and other combinations are also possible.

In some embodiments, the first sidelink control information and the second sidelink control information are sidelink control information that includes different fields. In some embodiments, the first sidelink control information includes a first field, the second sidelink control information includes a second field, and the first field and the second field are two different information fields. Exemplarily, the first sidelink control information includes a demodulation reference signal (DMRS) pattern indication field and a DMRS port number indication field, and the second sidelink control information includes a retransmission index and a time gap indication field between initial transmission and retransmission. It should be noted that this is merely an exemplary illustration where the first field includes the DMRS pattern indication field and the DMRS port number indication field, and the second field includes the retransmission index and the time gap indication field between initial transmission and retransmission. The present disclosure does not limit the first field and the second field to these combinations, and other combinations are also possible.

In some embodiments, the first resource is a resource that the terminal device has already selected (referred to as “selected” for short) by the terminal device, which can be a time-frequency resource. For example, the first resource is a time-frequency resource selected by the terminal device. In some embodiments, for a re-evaluation scenario, the first resource is a resource that the terminal device has selected but has not indicated by transmitting the first sidelink control information. For example, the first resource is a time-frequency resource that the terminal device has selected but has not indicated by transmitting the first sidelink control information. In some embodiments, for a pre-emption scenario, the first resource is a resource that the terminal device has selected and indicated by transmitting the first sidelink control information. For example, the first resource is a time-frequency resource that the terminal device has selected and indicated by transmitting the first sidelink control information.

In some embodiments, the first resource is configured by the higher layer of the terminal device to the physical layer of the terminal device. The physical layer detects whether the first resource meets a first condition. In the case that the first resource meets the first condition, the physical layer reports the first resource to the higher layer, and then the higher layer reselects the reported first resource. In some embodiments, in the case that the first resource does not meet the first condition, the physical layer does not report the first resource to the higher layer. In addition, the first resource is any resource that the terminal device has selected but has not indicated by transmitting the first sidelink control information, or any resource that the terminal device has selected and has indicated by transmitting the first sidelink control information. The higher layer may configure one or more first resources to the physical layer. The physical layer detects whether each of the one or more first resources meets the first condition and reports the first resource that meets the first condition to the higher layer, and then the higher layer reselects the reported first resource.

In the technical solutions according to the embodiments of the present disclosure, the terminal device performs resource reselection based on the first sidelink control information and the second sidelink control information monitored upon completion of resource selection. Since the first sidelink control information and the second sidelink control information are different sidelink control information, for example, sidelink control information from two different communication systems, by adopting the technical solutions, in scenarios where resource pools of the two different communication systems overlap, the conflicts between the resources that have already been selected by the terminal device in the first communication system and the reserved resources of other terminal devices in the first communication system as well as terminal devices in the second communication system are avoided, especially conflicts with high-priority services are avoided, such that communication reliability is enhanced.

A description is provided below for the condition 1.

In some embodiments, the first resource not being within the first resource set means that the first resource set does not include the first resource. In some embodiments, the first resource set is a candidate resource set determined by the terminal device based on the first sidelink control information and the second sidelink control information. The terminal device selects transmission resources from the candidate resource set (i.e., the first resource set) and then uses the selected transmission resources to transmit data. In some embodiments, the terminal device randomly selects transmission resources from the candidate resource set (i.e., the first resource set), or selects according to a certain strategy, which is not limited in the present disclosure.

In some embodiments, upon determining the candidate resource set (i.e., the first resource set) by the terminal device based on the first sidelink control information and the second sidelink control information, the terminal device determines whether the selected first resource is within the first resource set. In the case that the first resource is within the first resource set, the terminal device uses the selected first resource to transmit data; in the case that the first resource is not within the first resource set, the terminal device reselects the first resource, for example, by selecting a third resource from the first resource set to replace the first resource.

In some embodiments, the method for the terminal device to determine the first resource set is as follows:
determining a resource selection window and a resource sensing window;
determining the available resources within the resource selection window as an initialized resource set; and
acquiring the first resource set by excluding resources from the initialized resource set by a resource exclusion process, wherein the resource exclusion process includes a first exclusion process and a second exclusion process, wherein the first exclusion process is used to exclude resources based on the first sidelink control information monitored within the resource sensing window, and the second exclusion process is used to exclude resources based on the second sidelink control information monitored within the resource sensing window.

In the embodiments of the present disclosure, there are no limitations on the time interval corresponding to the resource selection window. Exemplarily, the resource selection window may adopt the design method in the NR V2 X system. For example, the resource selection window starts from n+T₁ and ends at n+T₂, where the time unit n (such as slot n) is a time unit that triggers resource selection or reselection or a time unit for the higher layer to trigger the physical layer to report the candidate resource set. The descriptions of T₁ and T₂ may be referred to above. In some embodiments, in the case that the first sidelink control information is the sidelink control information in the NR system, the resource selection window adopts the above-described design method in the NR V2X system.

In some embodiments, the number of resource sensing windows is either two or one.

In some embodiments, in the case that the number of resource sensing windows is two, the resource sensing windows include a first resource sensing window and a second resource sensing window. The terminal device monitors the first sidelink control information within the first resource sensing window and monitors the second sidelink control information within the second resource sensing window. The first resource sensing window is different from the second resource sensing window. For example, the time interval corresponding to the first resource sensing window is different from the time interval corresponding to the second resource sensing window. Exemplarily, the first resource sensing window spans from n-T₀₀ to n-T_{proc,0} (excluding n-_{proc,0)}, wherein T₀₀ is 1100 or 100 ms, and T_{proc,0} is as described above. The second resource sensing window spans from n-T₁₀ to n (excluding n), wherein T₁₀ is 1000 ms. The time unit n (such as slot n) is a time unit that triggers resource selection or reselection or a time unit for the higher layer to trigger the physical layer to report the candidate resource set. In some embodiments, in the case that the first sidelink control information is the sidelink control information in the NR system, the first resource sensing window adopts the design method in the NR V2X system, such as spanning from n-T₀₀ to n-T_{proc,0} (excluding n-_{proc,0}). In some embodiments, in the case that the second sidelink control information is the sidelink control information in the LTE system, the second resource sensing window adopts the design method in the LTE V2X system, spanning from n-T₁₀ to n (excluding n).

In some embodiments, in the case that the number of resource sensing window is one, in one example, the resource sensing window includes a first resource sensing window, and the terminal device monitors the first sidelink control information and the second sidelink control information within the first resource sensing window. In another example, the resource sensing window includes a second resource sensing window, and the terminal device monitors the first sidelink control information and the second sidelink control information within the second resource sensing window. The first resource sensing window is different from the second resource sensing window. For the description regarding the first resource sensing window and the second resource sensing window, reference may be made to the description in the previous paragraph, which will not be repeated here.

In some embodiments, the terminal device monitors the first sidelink control information and the second sidelink control information within the resource sensing window. Exemplarily, the resource sensing window spans from n-T₀₀ to n-T_{proc,0} (excluding n-T_{proc,0}), wherein Too is 1100 or 100 ms, and T_{proc,0} is as described above.

In some embodiments, the first exclusion process is performed prior to the second exclusion process, or the first exclusion process is performed upon the second exclusion process.

In some embodiments, the resource exclusion process further includes a third exclusion process, and the third exclusion process is used to exclude resources based on the non-monitored time unit within the resource sensing window.

In some embodiments, in the case that the number of resource sensing window is one, the third exclusion process is used to exclude resources based on the non-monitored time unit within this single resource sensing window. For example, in the case that the resource sensing window is a first resource sensing window, the third exclusion process is used to exclude resources based on the non-monitored time unit within the first resource sensing window. For another example, in the case that the resource sensing window is a second resource sensing window, the third exclusion process is used to exclude resources based on the non-monitored time unit within the second resource sensing window.

In some embodiments, in the case that the number of resource sensing windows is two, such as when the resource sensing windows include the first resource sensing window and the second resource sensing window described above, the third exclusion process is used to exclude resources based on the non-monitored time unit within the first resource sensing window and the non-monitored time unit within the second resource sensing window, that is, excluding resources based on the non-monitored time units from the union set of both the first resource sensing window and the second resource sensing window; or the third exclusion process is used to exclude resources based only on the non-monitored time unit within the first resource sensing window; or the third exclusion process is used to exclude resources based only on the non-monitored time unit within the second resource sensing window.

In some embodiments, the terminal device, upon determining the resource selection window and the resource sensing window, performs the resource exclusion process as described in the following processes (1) to (5):
(1) The terminal device initializes all available resources within the resource selection window into a resource set A. Any resource in the resource set A is denoted as R(x, y), wherein x and y represent the frequency domain location and time domain location of the resource, respectively; the initial number of resources in the resource set A is denoted as Mₜₒₜₐₗ.
(2) The terminal device excludes resources based on the non-monitored time unit within the resource sensing window, i.e., the terminal device performs the third exclusion process.
(3) The terminal device excludes resources based on the first sidelink control information monitored within the resource sensing window, i.e., the terminal device performs the first exclusion process.
(4) The terminal device excludes resources based on the second sidelink control information monitored within the resource sensing window, i.e., the terminal device performs the second exclusion process.
(5) In the case that the number of the remaining resources in the resource set A is less than Mₜₒₜₐₗ*X, the RSRP threshold is raised by 3 dB, and process (1) is re-performed. The X is configured on the network or pre-configured.

The resource set A upon the above resource exclusion process, i.e., the resource set A upon process (5), is the first resource set.

In some embodiments, the terminal device skips process (2). In some embodiments, in the case that upon performing process (2), the number of the remaining resources in the resource set A is less than Mₜₒₜₐₗ* X, the terminal device initializes the resource set A to the resource set A prior to performing process (2) and then performs the subsequent processes.

In some embodiments, the order in which the terminal device performs processes (2), (3), and (4) is adjusted. For example, process (2) is performed first, followed by process (3), and then process (4); or process (2) is performed first, followed by process (4), and then process (3).

In some embodiments, the third exclusion process includes: determining Q3 time units corresponding to the non-monitored time unit based on the resource reservation period in the first resource reservation period set and/or the second resource reservation period set, and the non-monitored time unit, wherein Q3 is a positive integer; and in the case that the Q3 time units overlap with the target resource in the resource set or with the periodic resource corresponding to the target resource, excluding the target resource from the resource set.

For example, the target resource is resource R(x, y), wherein x and y indicate frequency domain location and time domain location of the resource, respectively, and for the aforementioned process (2), the terminal device determines the corresponding Q3 time units based on each resource reservation period in the first resource reservation period set and/or the second resource reservation period set, and the non-monitored time unit. In the case that the Q3 time units overlap with the R(x, y) or with a series of periodic resources corresponding to R(x, y), then the resource R(x, y) is excluded from the resource set A.

In some embodiments, the first resource reservation period set includes one or more of the resource reservation periods allowed in a first communication system; or the first resource reservation period set includes one or more of the resource reservation periods allowed in the first communication system and one or more of the resource reservation periods allowed in a second communication system. The first communication system corresponds to the first sidelink control information, and the second communication system corresponds to the second sidelink control information.

In some embodiments, the second resource reservation period set includes one or more of the resource reservation periods allowed in the second communication system, wherein the second communication system corresponds to the second sidelink control information.

In some embodiments, the third exclusion process includes: determining Q3 time units corresponding to the non-monitored time unit based on the resource reservation periods in the first resource reservation period set and the non-monitored time unit. The configuration of the resource pool includes a resource reservation period set, such as the first resource reservation period set, and the first resource reservation period set includes one or more of the resource reservation periods allowed in the first communication system.

In some embodiments, the third exclusion process includes: determining Q3 time units corresponding to the non-monitored time unit based on the resource reservation periods in the first resource reservation period set and the non-monitored time unit. The configuration of the resource pool includes a resource reservation period set, such as the first resource reservation period set, and the first resource reservation period set includes one or more of the resource reservation periods allowed in the first communication system and one or more of the resource reservation periods allowed in the second communication system.

In some embodiments, the third exclusion process includes: determining Q3 time units corresponding to the non-monitored time unit based on the resource reservation periods in the first resource reservation period set and the second resource reservation period set, and the non-monitored time unit. The configuration of the resource pool includes two resource reservation period sets, such as the first resource reservation period set and the second resource reservation period set. The first resource reservation period set includes one or more of the resource reservation periods allowed in the first communication system, and the second resource reservation period set includes one or more of the resource reservation periods allowed in the second communication system.

Exemplarily, the first communication system is an NR system, and the second communication system is an LTE system.

In some embodiments, the first exclusion process includes: determining Q1 time units corresponding to a first time unit based on the first time unit in which the first sidelink control information is monitored and the resource reservation period indicated in the first sidelink control information, and assuming that the first sidelink control information with the same content is received within the Q1 time units, wherein Q1 is a positive integer; and excluding a target resource from the resource set in the case that resources indicated by the monitored first sidelink control information and the assumed-to-be-received first sidelink control information are overlapped with the target resource in the initialized resource set or with a periodic resource corresponding to the target resource and a first RSRP threshold condition is met. Alternatively, the first exclusion process includes: determining whether the resource indicated by the monitored first sidelink control information is overlapped with the target resource in the resource set or with the periodic resource corresponding to the target resource; and excluding the target resource from the resource set in the case that the resources overlap and the first RSRP threshold condition is met.

For example, the target resource is resource R(x, y), and for the aforementioned process (3), the terminal device determines the corresponding Q1 time units based on the time unit in which the first sidelink control information is monitored and the resource reservation period indicated in the first sidelink control information. Moreover, it is assumed that the first sidelink control information with the same content will be received within the Q1 time units. In the case that the resources indicated by the “Time resource assignment” and “Frequency resource assignment” in the monitored first sidelink control information and the assumed-to-be-received first sidelink control information are overlapped with R(x, y) or a series of periodic resources corresponding to R(x, y) and the first RSRP threshold condition is met, then the resource R(x, y) is excluded from the resource set A. Alternatively, the terminal device determines whether the resource indicated by the “Time resource assignment” and “Frequency resource assignment” in the monitored first sidelink control information is overlapped with R(x, y) or with a series of periodic resources corresponding to R(x, y), and excludes the resource R(x, y) from the resource set A in the case that the resources overlap and the first RSRP threshold condition is met. The the first RSRP threshold condition being met means that the RSRP of the PSCCH where the monitored first sidelink control information is located, or the RSRP of the PSSCH scheduled by the PSCCH, is greater than the first RSRP threshold. The first RSRP threshold may be determined based on the priority indicated in the first sidelink control information and the priority of data transmission.

In some embodiments, the second exclusion process includes: determining Q2 time units corresponding to a second time unit based on the second time unit in which the second sidelink control information is monitored and the resource reservation period indicated in the second sidelink control information, and assuming that the second sidelink control information with the same content is received within the Q2 time units, wherein Q2 is a positive integer; and excluding a target resource from the resource set in the case that the resources indicated by the monitored second sidelink control information and the assumed-to-be-received second sidelink control information are overlapped with the target resource in the resource set or with the periodic resource corresponding to the target resource and a second RSRP threshold condition is met.

For example, the target resource is resource R(x, y), and for the aforementioned process (₄), the terminal device determines the corresponding Q2 time units based on the time unit in which the second sidelink control information is monitored and the resource reservation period indicated in the second sidelink control information. Moreover, it is assumed that the second sidelink control information with the same content will be received within the Q2 time units. In the case that the resources indicated by the first to third information fields in the monitored second sidelink control information and the assumed-to-be-received second sidelink control information are overlapped with R(x, y) or a series of periodic resources corresponding to R(x, y) and the second RSRP threshold condition is met, then the resource R(x, y) is excluded from the resource set A. The second RSRP threshold condition being met means that the RSRP of the PSSCH scheduled by the monitored second sidelink control information is greater than the second RSRP threshold. The second RSRP threshold may be determined based on the priority indicated in the second sidelink control information and the priority of data transmission. In addition, the first information field refers to the “Frequency resource location of the initial transmission and retransmission” in the second sidelink control information, the second information field refers to the “Time gap between initial transmission and retransmission” in the second sidelink control information, and the third information field refers to the “Retransmission index” in the second sidelink control information.

In some embodiments, the same RSRP threshold table is configured for the first exclusion process and the second exclusion process. For example, by network configuration or pre-configuration, the same RSRP threshold table is configured for processes (3) and (4), that is, including the RSRP thresholds corresponding to all priority combinations. The first RSRP threshold is determined by looking up the table based on the priority indicated by the first sidelink control information and the priority of data transmission, and the second RSRP threshold is determined by looking up the table based on the priority indicated by the second sidelink control information and the priority of data transmission. Correspondingly, raising the RSRP threshold by 3 dB means raising the RSRP thresholds corresponding to various priority combinations by 3 dB.

In some embodiments, different RSRP threshold tables are configured for the first exclusion process and the second exclusion process. For example, by network configuration or pre-configuration, different RSRP threshold tables are configured for processes (3) and (4), referred to as the first RSRP threshold table and the second RSRP threshold table. The first RSRP threshold is determined by looking up the first RSRP threshold table based on the priority indicated by the first sidelink control information and the priority of data transmission. Similarly, the second RSRP threshold is determined by looking up the second RSRP threshold table based on the priority indicated by the second sidelink control information and the priority of data transmission. Correspondingly, raising the RSRP threshold by 3 dB means raising the RSRP thresholds corresponding to various priority combinations in the first RSRP threshold table and the second RSRP threshold table by 3 dB.

In some embodiments, the priority of data transmission mentioned above refers to the priority of the data that the terminal device is about to transmit (or send) or the priority of the data that the terminal device is currently transmitting (or sending).

In addition, the “time unit” mentioned in the embodiments of the present disclosure may be a slot, a subframe, or any other time unit, which is not limited in the present disclosure. For the “time unit” mentioned elsewhere herein, reference is made to this explanation, which will not be repeated.

A description is provided below for the condition 2.

In some embodiments, the second resource is the first resource; or, the second resource includes a series of resources that include the first resource, have the same frequency domain location as the first resource, and are spaced apart in the time domain location. In some embodiments, the time domain location spacing is determined based on the resource reservation period of the terminal device.

In some embodiments, the resource determined based on the first sidelink control information includes: the resource indicated by the first sidelink control information monitored in the first time unit; or the resources indicated by the first sidelink control information monitored in the first time unit and by the first sidelink control information assumed to be received in Q1 time units corresponding to the first time unit. The Q1 time units are determined based on the first time unit and the resource reservation period indicated in the first sidelink control information, and Q1 is a positive integer.

In some embodiments, in the case that the first sidelink control information received (i.e., monitored) by the terminal device does not include a resource reservation period field, the resource determined based on the first sidelink control information includes: the resource indicated by the first sidelink control information monitored in the first time unit. For example, the resource determined based on the first sidelink control information includes: the resource indicated by “Time resource assignment” and “Frequency resource assignment” in the monitored first sidelink control information.

In some embodiments, in the case that the first sidelink control information received (i.e., monitored) by the terminal device includes a resource reservation period field, the resource determined based on the first sidelink control information includes: the resources indicated by the first sidelink control information monitored in the first time unit and by the first sidelink control information assumed to be received in Q1 time units corresponding to the first time unit. The Q1 time units are determined based on the first time unit and the resource reservation period indicated in the first sidelink control information, and Q1 is a positive integer. For example, the terminal device determines the corresponding Q1 time units based on the time unit in which the first sidelink control information is monitored and the resource reservation period indicated in the first sidelink control information. Moreover, it is assumed that the first sidelink control information with the same content will be received within the Q1 time units. The resource determined based on the first sidelink control information includes: the resources indicated by “Time resource assignment” and “Frequency resource assignment” in the monitored first sidelink control information and the assumed-to-be-received first sidelink control information.

In some embodiments, the resource determined based on the second sidelink control information includes: the resources indicated by the second sidelink control information monitored in the second time unit and by the second sidelink control information assumed to be received in Q2 time units corresponding to the second time unit. The Q2 time units are determined based on the second time unit and the resource reservation period indicated in the second sidelink control information, and Q2 is a positive integer.

In some embodiments, the terminal device determines the corresponding Q2 time units based on the time unit in which the second sidelink control information is monitored and the resource reservation period indicated in the second sidelink control information. Moreover, it is assumed that the second sidelink control information with the same content will be received within the Q2 time units. The resource determined based on the second sidelink control information includes: the resources indicated by the first to third information fields in the monitored second sidelink control information and the assumed-to-be-received second sidelink control information. For the description regarding the first to third information fields, reference may be made to the above embodiments, which will not be repeated herein.

In some embodiments, in the case that the second resource is overlapped with the resource determined based on the first sidelink control information, then the RSRP threshold condition being met includes: the SL-RSRP of the PSCCH corresponding to the first sidelink control information or the PSSCH scheduled by the PSCCH is greater than or equal to the first RSRP threshold, and the first RSRP threshold is determined based on the priority indicated by the first sidelink control information and the priority of data transmission. In the case that the same RSRP threshold table (such as the first RSRP threshold table) is configured for the first exclusion process and the second exclusion process (i.e., processes (3) and (4) in the resource exclusion process described above), the first RSRP threshold is determined by looking up the first RSRP threshold table based on the priority indicated by the first sidelink control information and the priority of the terminal device's data transmission. In the case that different RSRP threshold tables (such as the first RSRP threshold table and the second RSRP threshold table) are configured for the first exclusion process and the second exclusion process (i.e., processes (3) and (4) in the resource exclusion process described above), the first RSRP threshold is determined by looking up the first RSRP threshold table based on the priority indicated by the first sidelink control information and the priority of the terminal device's data transmission. The first RSRP threshold table is the first RSRP threshold table used by the terminal device the last time it performed processes (1) to (5). For example, in the case that processes (1) to (5) are performed multiple times and the thresholds in the first RSRP threshold table are raised multiple times, the first RSRP threshold table is the first RSRP threshold table upon the last raising of thresholds.

In some embodiments, in the case that the second resource is overlapped with the resource determined based on the second sidelink control information, then the RSRP threshold condition being met includes: the SL-RSRP of the PSSCH scheduled by the second sidelink control information is greater than or equal to the second RSRP threshold, and the second RSRP threshold is determined based on the priority indicated by the second sidelink control information and the priority of data transmission. In the case that the same RSRP threshold table (such as the first RSRP threshold table) is configured for the first exclusion process and the second exclusion process (i.e., processes (3) and (4) in the resource exclusion process described above), the second RSRP threshold is determined by looking up the first RSRP threshold table based on the priority indicated by the second sidelink control information and the priority of the terminal device's data transmission. The first RSRP threshold table is the first RSRP threshold table used by the terminal device the last time it performed processes (1) to (5). For example, in the case that processes (1) to (5) are performed multiple times and the thresholds in the first RSRP threshold table are raised multiple times, the first RSRP threshold table is the first RSRP threshold table upon the last raising of thresholds. In the case that different RSRP threshold tables (such as the first RSRP threshold table and the second RSRP threshold table) are configured for the first exclusion process and the second exclusion process (i.e., processes (3) and (4) in the resource exclusion process described above), the second RSRP threshold is determined by looking up the second RSRP threshold table based on the priority indicated by the second sidelink control information and the priority of the terminal device's data transmission. The second RSRP threshold table is the second RSRP threshold table used by the terminal device the last time it performed processes (1) to (5). For example, in the case that processes (1) to (5) are performed multiple times and the thresholds in the second RSRP threshold table are raised multiple times, the second RSRP threshold table is the second RSRP threshold table upon the last raising of thresholds.

In some embodiments, the priority of data transmission mentioned above refers to the priority of the data that the terminal device is about to transmit (or send) or the priority of the data that the terminal device is currently transmitting (or sending)..

In some embodiments, the priority indicated by the first sidelink control information or the second sidelink control information being higher than the priority of data transmission and/or higher than the priority threshold, includes:

In the case that the sidelink control information meeting a first sub-condition is the first sidelink control information, then the priority indicated by the first sidelink control information meeting the first sub-condition is higher than the priority of data transmission; or the priority indicated by the first sidelink control information meeting the first sub-condition is higher than the priority of data transmission and higher than the first priority threshold.

In the case that the sidelink control information meeting the first sub-condition is the second sidelink control information, then the priority indicated by the second sidelink control information meeting the first sub-condition is higher than the priority of data transmission; or the priority indicated by the second sidelink control information meeting the first sub-condition is higher than the priority of data transmission and higher than the second priority threshold.

Here, the first sub-condition is that the second resource is overlapped with the resource determined based on the sidelink control information and the RSRP threshold condition is met. That is, the first sub-condition is the condition 2 described above.

In some embodiments, the first priority threshold is denoted as U, and the first priority threshold U is configured on the network, or pre-configured, or specified as a predefined value by standards, or dependent on the practice of the terminal device. In some embodiments, the first priority threshold U is a configuration parameter of the resource pool, or in other words, the first priority threshold U is configured within the resource pool.

In some embodiments, the second priority threshold is denoted as Z, and the second priority threshold Z is configured on the network, or pre-configured, or specified as a predefined value by standards, or dependent on the practice of the terminal device. In some embodiments, the second priority threshold Z is a configuration parameter of the resource pool, or in other words, the second priority threshold Z is configured within the resource pool.

Exemplarily, regardless of whether the sidelink control information meeting the first sub-condition (i.e., condition 2) is the first sidelink control information or the second sidelink control information, the condition 3 is met in the case that the priority indicated by the sidelink control information is higher than the priority of data transmission.

Exemplarily, the first priority threshold is the same as the second priority threshold, i.e., U and Z are the same parameters. In this case, regardless of whether the sidelink control information meeting the first sub-condition (i.e., condition 2) is the first sidelink control information or the second sidelink control information, the priority indicated by the sidelink control information needs to be higher than the threshold U and higher than the priority of data transmission to meet the condition 3.

Exemplarily, the first priority threshold is different from the second priority threshold, i.e., U and Z are different parameters. In the case that the first sidelink control information meets the first sub-condition (i.e., condition 2), the priority indicated by the first sidelink control information needs to be higher than the threshold U and higher than the priority of data transmission to meet the condition 3; in the case that the second sidelink control information meets the first sub-condition (i.e., condition 2), the priority indicated by the second sidelink control information needs to be higher than the threshold Z and higher than the priority of data transmission to meet the condition 3.

In some embodiments, the priority of data transmission mentioned above refers to the priority of the data that the terminal device is about to transmit (or send) or the priority of the data that the terminal device is currently transmitting (or sending).

In addition, the priority is represented by a priority value. In the case that a larger priority value indicates a higher priority, then the priority indicated by the sidelink control information being higher than the priority of data transmission and/or higher than the priority threshold mentioned above means that the priority value indicated by the sidelink control information is greater than the priority value of data transmission and/or greater than the priority threshold; in the case that a smaller priority value indicates a higher priority, then the priority indicated by the sidelink control information being higher than the priority of data transmission and/or higher than the priority threshold mentioned above means that the priority value indicated by the sidelink control information is less than the priority value of data transmission and/or less than the priority threshold. For other descriptions of priority levels in the present disclosure, reference are made to this explanation.

In some embodiments, for a re-evaluation scenario, a method for resource reselection according to the embodiments of the present disclosure is as follows.

In the case that a first resource meets a first condition, the terminal device reselects the first resource. The first condition includes: the first resource is not within a first resource set; the first resource set is determined based on the first sidelink control information and the second sidelink control information, wherein the first sidelink control information is different from the second sidelink control information.

In such embodiments, for the re-evaluation scenario, the first condition includes the condition 1. In the case that the first resource meets the condition 1, the terminal device reselects the first resource.

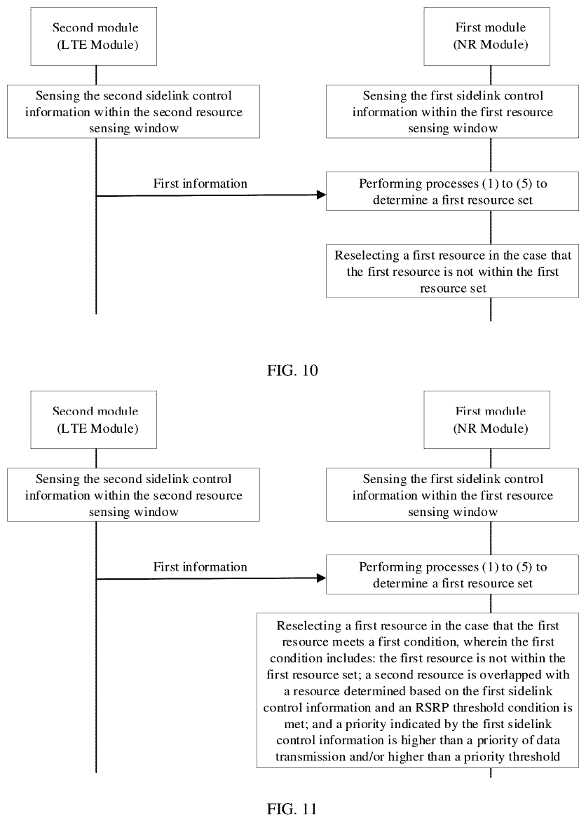

Exemplarily, as shown in FIG. 10, the above processes are described from the perspective of the internal modules of the terminal device. The terminal device includes a first module and a second module, and the first module and the second module are two different functional modules. For example, the first module is an NR module, and the second module is an LTE module. In some embodiments, the LTE module monitors the second sidelink control information within the second resource sensing window. The LTE module transmits the first information to the NR module, and the first information includes the monitored second sidelink control information. In some embodiments, the first information further includes at least one of: the time unit corresponding to the monitored second sidelink control information (such as subframe or slot), the RSRP of the PSSCH scheduled by the monitored second sidelink control information, the second resource reservation period set, the set of subframes or slots that may belong to the resource pool, Pstep (used for converting resource reservation period to logical slots in the second communication system, Pstep is determined according to time division duplexing (TDD) configuration), TDD configuration (including uplink and downlink configuration, such as the ratio of uplink subframes to downlink subframes), frequency domain resource configuration of the resource pool of the monitored second sidelink control information (such as the frequency-domain start point of the resource pool, the width of sub-channels within the resource pool, the number of sub-channels within the resource pool, etc.). The NR module monitors the first sidelink control information within the first resource sensing window, determines the resource selection window, and performs the processes (1) to (5) described above to determine the first resource set, and in process (4), uses the first information provided by the LTE module for resource exclusion. For the first resource that has already been selected by the NR module but not indicated by transmitting the first sidelink control information, in the case that the first resource is not within the first resource set, the NR module reselects the first resource within the first resource set.

Exemplarily, as shown in FIG. 7, resources x, y, z, u, and v are time-frequency resources already selected by the terminal device in slot n, with resource y located in slot m. For the resources z and u, which the terminal device is about to indicate for the first time by transmitting the first sidelink control information on the resource y (where the resource y has already been indicated by the first sidelink control information in the resource x), the terminal device determines the resource selection window 10 and the resource sensing window 20 at least in slot m-T₃, and performs the above processes (1) to (5) for resource exclusion to obtain a first resource set. In the case that the resources z and/or u are not in the first resource set, the terminal device performs the aforementioned process 2 to reselect the time-frequency resource from the resources z and u that are not in the first resource set. Depending on the practice of the terminal device, the terminal device may also reselect any resource that has already been selected but not indicated by transmitting the first sidelink control information, such as any one or more of the resources z, u, and v. The aforementioned T₃ is equal to T_{proc,1}.

In some embodiments, for a pre-emption scenario, a method for resource reselection according to the embodiments of the present disclosure is as follows.

In the case that the first resource meets the first condition, the terminal device reselects the first resource.

Here, the first condition includes the following items:

The first resource is not within the first resource set, where the first resource set is determined based on the first sidelink control information and the second sidelink control information (condition 1).

The second resource is overlapped with the resource determined based on the first sidelink control information and the RSRP threshold condition is met, wherein the second resource is a resource determined based on the first resource (condition 2).

The priority indicated by the first sidelink control information is higher than the priority of data transmission and/or higher than the priority threshold (condition 3).

The first sidelink control information is different from the second sidelink control information.

In such embodiments, for the pre-emption scenario, the first condition includes the condition 1, the condition 2, and the condition 3. In the case that the first resource meets the aforementioned three conditions, the terminal device reselects the first resource.

Exemplarily, as shown in FIG. 11, the above processes are described from the perspective of the internal modules of the terminal device. The terminal device includes a first module and a second module, and the first module and the second module are two different functional modules. For example, the first module is an NR module, and the second module is an LTE module. In some embodiments, the LTE module monitors the second sidelink control information within the second resource sensing window. The LTE module transmits the first information to the NR module, wherein the first information includes the monitored second sidelink control information. In some embodiments, the first information further includes at least one of: the time unit corresponding to the monitored second sidelink control information (such as subframe or slot), the RSRP of the PSSCH scheduled by the monitored second sidelink control information, the second resource reservation period set, the set of subframes or slots that may belong to the resource pool, Pstep (used for converting resource reservation period to logical slots in the second communication system, Pstep is determined according to TDD configuration), TDD configuration (including uplink and downlink configuration, such as the ratio of uplink subframes to downlink subframes), frequency domain resource configuration of the resource pool of the monitored second sidelink control information (such as the frequency-domain start point of the resource pool, the width of sub-channels within the resource pool, the number of sub-channels within the resource pool, etc.). The NR module monitors the first sidelink control information within the first resource sensing window, determines the resource selection window, and performs the processes (1) to (5) described above to determine the first resource set, and in process (4), uses the first information provided by the LTE module for resource exclusion. For the first resource that has already been selected by the NR module and indicated by transmitting the first sidelink control information, in the case that the first resource meets the first condition, the NR module reselects the first resource within the first resource set. The aforementioned first condition includes: The first resource is not within the first resource set, the second resource is overlapped with the resource determined based on the first sidelink control information and the RSRP threshold condition is met, and the priority indicated by the first sidelink control information is higher than the priority of data transmission and/or higher than the priority threshold. The second resource is determined based on the first resource. In some embodiments, the second resource is the first resource; or the second resource includes a series of resources that include the first resource, have the same frequency domain location as the first resource, and are spaced apart in the time domain location.

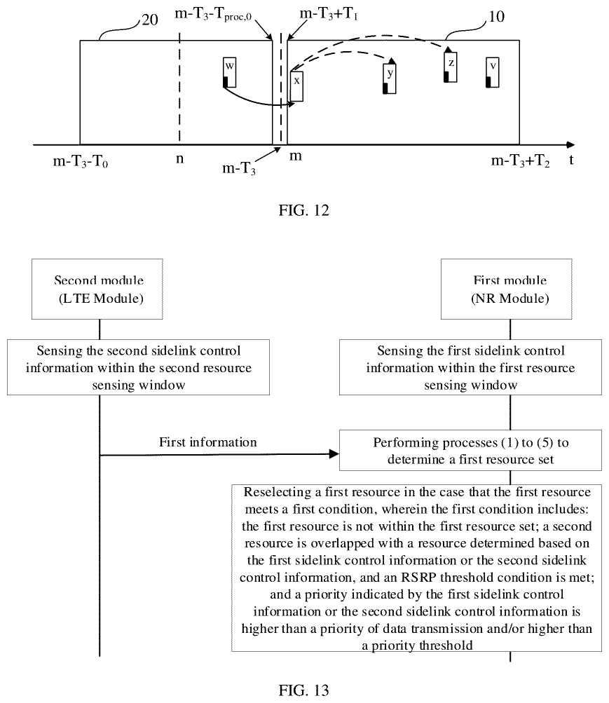

Exemplarily, as shown in FIG. 12, resources w, x, y, z, and v are time-frequency resources already selected by the terminal device in slot n, with resource x located in slot m. For the resource x, which the terminal device is about to indicate by transmitting the first sidelink control information on the resource x and has already been indicated by the previously transmitted first sidelink control information, the terminal device determines the resource selection window 10 and the resource sensing window 20 at least in slot m-T₃ and performs the above processes (1) to (5) to exclude resources within the resource selection window 10 to determine a first resource set. In the case that the resource x meets the first condition, i.e., it meets the following: the resource x is not within the first resource set, the resource corresponding to the resource x is overlapped with the resource determined based on the first sidelink control information and the RSRP threshold condition is met, and the priority indicated by the first sidelink control information is higher than the priority of data transmission and/or higher than the priority threshold, then the terminal device reselects the resource x within the first resource set. In addition, in the case that resource reselection is triggered, depending on the practice of the terminal device, the terminal device may reselect any resource that has already been selected but not indicated by transmitting the first sidelink control information, such as any one or more of resources y, z, and v. The aforementioned T₃ is equal to T_{proc,1}. The resource corresponding to the resource x is the resource x, or the resource includes a series of resources that include the resource x, have the same frequency domain location as the resource x, and are spaced apart in the time domain location.

In some embodiments, for a pre-emption scenario, a method for resource reselection according to the embodiments of the present disclosure is as follows.

In the case that the first resource meets the first condition, the terminal device reselects the first resource.

The first condition includes the following items.

The first resource is not within a first resource set, wherein the first resource set is determined based on first sidelink control information and second sidelink control information (condition 1).

The second resource is overlapped with the resource determined based on the first sidelink control information or the second sidelink control information, and the RSRP threshold condition is met, wherein the second resource is a resource determined based on the first resource (condition 2).

The priority indicated by the first sidelink control information or the second sidelink control information is higher than the priority of data transmission and/or higher than the priority threshold (condition 3).

The first sidelink control information is different from the second sidelink control information.

In such embodiments, for the pre-emption scenario, the first condition includes the condition 1, the condition 2, and the condition 3. In the case that the first resource meets the aforementioned three conditions, the terminal device reselects the first resource.

Exemplarily, as shown in FIG. 13, the above processes are described from the perspective of the internal modules of the terminal device. The terminal device includes a first module and a second module, and the first module and the second module are two different functional modules. For example, the first module is an NR module, and the second module is an LTE module. In some embodiments, the LTE module monitors the second sidelink control information within the second resource sensing window. The LTE module tranmsmits the first information to the NR module, and the first information includes the monitored second sidelink control information. In some embodiments, the first information further includes at least one of: the time unit corresponding to the monitored second sidelink control information (such as subframe or slot), the RSRP of the

PSSCH scheduled by the monitored second sidelink control information, the second resource reservation period set, the set of subframes or slots that may belong to the resource pool, Pstep (used for converting resource reservation period to logical slots in the second communication system, Pstep is determined according to TDD configuration), TDD configuration (including uplink and downlink configuration, such as the ratio of uplink subframes to downlink subframes), frequency domain resource configuration of the resource pool of the monitored second sidelink control information (such as the frequency-domain start point of the resource pool, the width of sub-channels within the resource pool, the number of sub-channels within the resource pool, etc.). The NR module monitors the first sidelink control information within the first resource sensing window, determines the resource selection window, and performs the processes (1) to (5) described above to determine the first resource set, and in process (4), uses the first information provided by the LTE module for resource exclusion. For the first resource that has already been selected by the NR module and indicated by transmitting the first sidelink control information, in the case that the first resource meets the first condition, the NR module reselects the first resource within the first resource set. The aforementioned first condition includes: The first resource is not within the first resource set, the second resource is overlapped with the resource determined based on the first sidelink control information or the second sidelink control information, and the RSRP threshold condition is met, and the priority indicated by the first sidelink control information or the second sidelink control information is higher than the priority of data transmission and/or higher than the priority threshold. The second resource is determined based on the first resource. In some embodiments, the second resource is the first resource; or the second resource includes a series of resources that include the first resource, have the same frequency domain location as the first resource, and are spaced apart in the time domain location.

Exemplarily, as shown in FIG. 12, resources w, x, y, z, and v are time-frequency resources already selected by the terminal device in slot n, with resource x located in slot m. For the resource x, which the terminal device is about to indicate by transmitting the first sidelink control information on the resource x and has already been indicated by the previously transmitted first sidelink control information, the terminal device determines the resource selection window 10 and the resource sensing window 20 at least in slot m-T₃ and performs the above processes (1) to (5) to exclude resources within the resource selection window 10 to determine a first resource set. In the case that the resource x meets the first condition, i.e., it meets the following: the resource x is not within the first resource set, the resource corresponding to the resource x is overlapped with the resource determined based on the first sidelink control information or the second sidelink control information and the RSRP threshold condition is met, and the priority indicated by the first sidelink control information or the second sidelink control information is higher than the priority of data transmission and/or higher than the priority threshold, then the terminal device reselects the resource x within the first resource set. In addition, in the case that resource reselection is triggered, depending on the practice of the terminal device, the terminal device may reselect any resource that has already been selected but not indicated by transmitting the first sidelink control information, such as any one or more of resources y, z, and v. The aforementioned T₃ is equal to T_{proc,1}. The resource corresponding to the resource x is the resource x, or the resource includes a series of resources that include the resource x, have the same frequency domain location as the resource x, and are spaced apart in the time domain location.

The following is an apparatus embodiment of the present disclosure that may be configured to implement the method embodiments of the present disclosure. For details that are not disclosed in the apparatus embodiment of the present disclosure, reference is made to the method embodiments of the present disclosure.

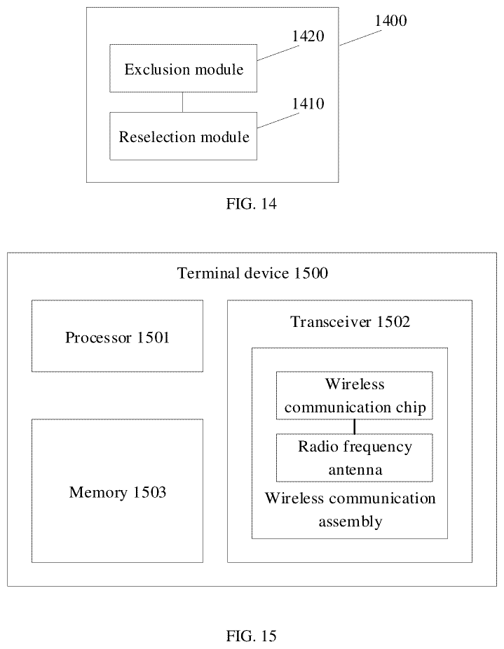

Referring to FIG. 14, a block diagram of an apparatus for resource reselection according to some embodiments of the present disclosure is shown. The apparatus has the function of implementing the above method embodiments, and the function may be achieved by hardware or by hardware executing corresponding software. The apparatus may be the terminal device mentioned above or may be provided within the terminal device. As shown in FIG. 14, the apparatus 1400 includes: a reselection module 1410.

The reselection module 1410 is configured to reselect a first resource in the case that the first resource meets a first condition.

The first condition includes at least one of the following items:
the first resource is not within the first resource set, where the first resource set is determined based on the first sidelink control information and the second sidelink control information;
the second resource is overlapped with the resource determined based on the first sidelink control information or the second sidelink control information, and the RSRP threshold condition is met, where the second resource is a resource determined based on the first resource; or
the priority indicated by the first sidelink control information or the second sidelink control information is higher than the priority of data transmission and/or higher than the priority threshold.

The first sidelink control information is different from the second sidelink control information.

In some embodiments, the first resource is a resource that the terminal device has selected but has not indicated by transmitting the first sidelink control information.

In some embodiments, the first resource is a resource that the terminal device has selected and has indicated by transmitting the first sidelink control information.

In some embodiments, as shown in FIG. 14, the apparatus 1400 further includes an exclusion module 1420, configured to:
determine a resource selection window and a resource sensing window;
use the available resources within the resource selection window as an initialized resource set; and
acquire the first resource set by excluding resources from the initialized resource set by a resource exclusion process, wherein the resource exclusion process includes a first exclusion process and a second exclusion process, wherein the first exclusion process is used to exclude resources based on the first sidelink control information monitored within the resource sensing window, and the second exclusion process is used to exclude resources based on the second sidelink control information monitored within the resource sensing window.

In some embodiments, the first exclusion process is performed prior to the second exclusion process; or, the first exclusion process is performed upon the second exclusion process.

In some embodiments, the resource exclusion process further includes a third exclusion process, wherein the third exclusion process is used to exclude resources based on the non-monitored time unit within the resource sensing window.

In some embodiments, the third exclusion process includes:
determining Q3 time units corresponding to the non-monitored time unit based on the resource reservation period in the first resource reservation period set and/or the second resource reservation period set, and the non-monitored time unit, wherein Q3 is a positive integer; and
in the case that the Q3 time units is overlapped with a target resource in the initialized resource set or with the periodic resource corresponding to the target resource, excluding the target resource from the initialized resource set.

In some embodiments, the first resource reservation period set includes one or more of the resource reservation periods allowed in a first communication system; or the first resource reservation period set includes one or more of the resource reservation periods allowed in the first communication system and one or more of the resource reservation periods allowed in a second communication system. The first communication system corresponds to the first sidelink control information, and the second communication system corresponds to the second sidelink control information.

In some embodiments, the second resource reservation period set includes one or more of resource reservation periods allowed in the second communication system, wherein the second communication system corresponds to the second sidelink control information.

In some embodiments, the first exclusion process includes:
determining Q1 time units corresponding to a first time unit based on the first time unit in which the first sidelink control information is monitored and the resource reservation period indicated in the first sidelink control information, and assuming that the first sidelink control information with the same content is to be received within the Q1 time units, wherein Q1 is a positive integer; and excluding a target resource from the initialized resource set in the case that the resources indicated by the monitored first sidelink control information and the assumed-to-be-received first sidelink control information are overlapped with the target resource in the initialized resource set or with the periodic resource corresponding to the target resource and a first RSRP threshold condition is met; or
determining whether the resource indicated by the monitored first sidelink control information is overlapped with the target resource in the initialized resource set or with the periodic resource corresponding to the target resource; and excluding the target resource from the initialized resource set in the case that the resources overlap and the first RSRP threshold condition is met.

In some embodiments, the second exclusion process includes:
determining Q2 time units corresponding to a second time unit based on the second time unit in which the second sidelink control information is monitored and the resource reservation period indicated in the second sidelink control information, and assuming that the second sidelink control information with the same content is to be received within the Q2 time units, wherein Q2 is a positive integer; and excluding a target resource from the initialized resource set in the case that the resources indicated by the monitored second sidelink control information and the assumed-to-be-received second sidelink control information are overlapped with the target resource in the initialized resource set or with the periodic resource corresponding to the target resource and a second RSRP threshold condition is met.

In some embodiments, the same RSRP threshold table is configured for the first exclusion process and the second exclusion process; or, different RSRP threshold tables are configured for the first exclusion process and the second exclusion process.

In some embodiments, the resource sensing window includes a first resource sensing window and a second resource sensing window.

The terminal device monitors the first sidelink control information within the first resource sensing window and monitors the second sidelink control information within the second resource sensing window.

Here, the first resource sensing window is different from the second resource sensing window.

In some embodiments, the resource sensing window includes a first resource sensing window, and the terminal device monitors the first sidelink control information and the second sidelink control information within the first resource sensing window; or, the resource sensing window includes a second resource sensing window, and the terminal device monitors the first sidelink control information and the second sidelink control information within the second resource sensing window. The first resource sensing window is different from the second resource sensing window.

In some embodiments, the second resource is the first resource; or, the second resource includes a series of resources that include the first resource, have the same frequency domain location as the first resource, and are spaced apart in the time domain location.

In some embodiments, the resources determined based on the first sidelink control information include:

the resource indicated by the first sidelink control information monitored in the first time unit;

the resources indicated by the first sidelink control information monitored in the first time unit and by the first sidelink control information assumed to be received in Q1 time units corresponding to the first time unit. Here, the Q1 time units are determined based on the first time unit and the resource reservation period indicated in the first sidelink control information, and Q1 is a positive integer.

In some embodiments, the resource determined based on the second sidelink control information includes: the resources indicated by the second sidelink control information monitored in the second time unit and by the second sidelink control information assumed to be received in Q2 time units corresponding to the second time unit. Here, the Q2 time units are determined based on the second time unit and the resource reservation period indicated in the second sidelink control information, and Q2 is a positive integer.

In some embodiments, in the case that the second resource is overlapped with the resource determined based on the first sidelink control information, then the RSRP threshold condition being met includes: the SL-RSRP of the PSCCH corresponding to the first sidelink control information or the PSSCH scheduled by the PSCCH is greater than or equal to the first RSRP threshold, and the first RSRP threshold is determined based on the priority indicated by the first sidelink control information and the priority of data transmission.

In some embodiments, in the case that the second resource is overlapped with the resource determined based on the second sidelink control information, then the RSRP threshold condition being met includes: the SL-RSRP of the PSSCH scheduled by the second sidelink control information is greater than or equal to the second RSRP threshold, and the second RSRP threshold is determined based on the priority indicated by the second sidelink control information and the priority of data transmission.

In some embodiments, the priority indicated by the first sidelink control information or the second sidelink control information being higher than the priority of data transmission and/or higher than the priority threshold, includes:

In the case that the sidelink control information meeting a first sub-condition is the first sidelink control information, then the priority indicated by the first sidelink control information meeting the first sub-condition is higher than the priority of data transmission; or, the priority indicated by the first sidelink control information meeting the first sub-condition is higher than the priority of data transmission and higher than the first priority threshold.

In the case that the sidelink control information meeting the first sub-condition is the second sidelink control information, then the priority indicated by the second sidelink control information meeting the first sub-condition is higher than the priority of data transmission; or, the priority indicated by the second sidelink control information meeting the first sub-condition is higher than the priority of data transmission and higher than the second priority threshold.

Here, the first sub-condition is that the second resource is overlapped with the resource determined based on the sidelink control information and the RSRP threshold condition is met.

In some embodiments, the first priority threshold is the same as the second priority threshold; or, the first priority threshold is different from the second priority threshold.

In some embodiments, the reselection module 1410 is configured to select a third resource from the first resource set to replace the first resource.

In some embodiments, the first sidelink control information is the sidelink control information in the NR system, and the second sidelink control information is the sidelink control information in the LTE system.

In the technical solutions according to the embodiments of the present disclosure, the terminal device performs resource reselection based on the monitored first sidelink control information and the second sidelink control information upon completion of resource selection. Since the first sidelink control information and the second sidelink control information are different sidelink control information, for example, sidelink control information from two different communication systems, by adopting the technical solutions, in scenarios where resource pools of the two different communication systems overlap, the conflicts between the resources that have already been selected by the terminal device in the first communication system and the reserved resources of other terminal devices in the first communication system as well as terminal devices in the second communication system are avoided, especially the conflicts with high-priority services are avoided, such that the communication reliability is enhanced.

It should be noted that, in the case that the apparatus according to the above embodiments implements the functions thereof, the division of the functional modules is merely exemplary. In practice, the above functions may be assigned to and completed by different functional modules according to actual needs, i.e., the internal structure of the apparatus may be divided into different functional modules, to implement all or a part of the above functions.

With regard to the apparatus in the above embodiments, the specific manner in which each module performs the operation has been described in detail in the embodiments related to the method and will not be described in detail herein. Reference is made to the above method embodiments for details that are not specified in the apparatus embodiment.

Referring to FIG. 15, a schematic structural diagram of a terminal device according to some embodiments of the present disclosure is shown. The terminal device 1500 includes: a processor 1501, a transceiver 1502, and a memory 1503.

The processor 1501 includes one or more processing cores, and the processor 1501 runs various functional applications and performs information processing by running software programs and modules.

The transceiver 1502 includes a receiver and a transmitter, which are implemented, for example, as the same wireless communication assembly that includes a wireless communication chip and a radio frequency antenna.

The memory 1503 is connected to the processor 1501 and the transceiver 1502.

The memory 1503 may be configured to store a computer program run by the processor, and the processor 1501 is configured to run the computer program to implement the processes in the above method embodiments.

In some embodiments, the processor 1501 is configured to reselect a first resource in the case that the first resource meets a first condition.

The first condition includes at least one of the following items.

The first resource is not within the first resource set, where the first resource set is determined based on the first sidelink control information and the second sidelink control information.

The second resource is overlapped with the resource determined based on the first sidelink control information or the second sidelink control information, and the RSRP threshold condition is met, wherein the second resource is a resource determined based on the first resource.

The priority indicated by the first sidelink control information or the second sidelink control information is higher than the priority of data transmission and/or higher than the priority threshold.

The first sidelink control information is different from the second sidelink control information.

Reference is made to the foregoing embodiments for details that are not specified in the embodiments, which are not repeated herein.

In addition, the memory may be implemented by any type or combination of volatile or non-volatile storage devices, including, but not limited to: magnetic or optical discs, electrically erasable programmable read-only memories, erasable programmable read-only memories, static random-access memories, read-only memories, magnetic memories, flash memories, and programmable read-only memories.

The embodiments of the present disclosure further provide a computer-readable storage medium storing one or more computer programs therein. The one or more computer programs, when loaded and run by a processor, cause the processor to perform the method for resource reselection described above. In some embodiments, the computer-readable storage medium includes: a read-only memory (ROM), a random-access memory (RAM), a solid state drive (SSD), an optical disk, etc. The RAM includes a resistance random-access memory (ReRAM) and a dynamic random access memory (DRAM).

The embodiments of the present disclosure further provide a chip including one or more programmable logic circuits and/or one or more program instructions. The chip, when running, is caused to perform the method for resource reselection described above.

The embodiments of the present disclosure further provide a computer program product or a computer program. The computer program product or the computer program includes computer instructions stored in a computer-readable storage medium. The computer instructions, when read from the computer-readable storage medium and executed by a processor, cause the processor to perform the method for resource reselection described above.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items. It may also indicate relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communication field including, for example, the LTE protocol, the NR protocol, and related protocols applied in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like. made within the spirit and principle of the present disclosure should fall within the protection scope of the present disclosure.

1. A method for resource reselection, applicable to a terminal device, the method comprising:
reselecting a first resource in a case that the first resource meets a first condition; wherein
the first condition comprises at least one of the following items:
the first resource is not within a first resource set, wherein the first resource set is determined based on first sidelink control information and second sidelink control information;
a second resource determined based on the first resource is overlapped with a resource determined based on first sidelink control information or second sidelink control information, and a reference signal received power (RSRP) threshold condition is met; or
a priority indicated by first sidelink control information or second sidelink control information is higher than a priority of data transmission and/or higher than a priority threshold,
wherein the first sidelink control information is different from the second sidelink control information;
wherein reselecting the first resource comprises: selecting a third resource from the first resource set to replace the first resource.

2. The method according to claim 1, wherein
the first resource is a resource that the terminal device has selected but has not indicated by transmitting the first sidelink control information; or
the first resource is a resource that the terminal device has selected and has indicated by transmitting the first sidelink control information.

3. The method according to claim 1, further comprising:
determining a resource selection window and a resource sensing window;
determining available resources within the resource selection window as an initialized resource set; and
acquiring the first resource set by excluding resources from the initialized resource set by a resource exclusion process, wherein the resource exclusion process comprises a first exclusion process and a second exclusion process, wherein the first exclusion process is used to exclude resources based on the first sidelink control information monitored within the resource sensing window, and the second exclusion process is used to exclude resources based on the second sidelink control information monitored within the resource sensing window;
wherein different RSRP threshold tables are configured for the first exclusion process and the second exclusion process;
wherein the resource exclusion process further comprises a third exclusion process, wherein the third exclusion process is used to exclude resources based on a non-monitored time unit within the resource sensing window.

4. The method according to claim 1, wherein
the second resource is the first resource; or
the second resource comprises a series of resources that comprise the first resource, have a same frequency domain location as the first resource, and are spaced apart in time domain location.

5. The method according to claim 1, wherein the resource determined based on the first sidelink control information comprises:
a resource indicated by the first sidelink control information monitored in a first time unit; or
resources indicated by the first sidelink control information monitored in a first time unit and by the first sidelink control information assumed to be received in Q1 time units corresponding to the first time unit, wherein the Q1 time units are determined based on the first time unit and a resource reservation period indicated in the first sidelink control information, and Q1 is a positive integer.

6. The method according to claim 1, wherein the resource determined based on the second sidelink control information comprises: resources indicated by the second sidelink control information monitored in a second time unit and by the second sidelink control information assumed to be received in Q2 time units corresponding to the second time unit, wherein the Q2 time units are determined based on the second time unit and a resource reservation period indicated in the second sidelink control information, and Q2 is a positive integer.

7. The method according to claim 1, wherein in a case that the second resource is overlapped with the resource determined based on the first sidelink control information, the RSRP threshold condition being met comprises: a sidelink reference signal received power (SL-RSRP) of a physical sidelink control channel (PSCCH) corresponding to the first sidelink control information or a physical sidelink shared channel (PSSCH) scheduled by the PSCCH being greater than or equal to a first RSRP threshold, wherein the first RSRP threshold is determined based on the priority indicated by the first sidelink control information and the priority of data transmission.

8. The method according to claim 1, wherein in a case that the second resource is overlapped with the resource determined based on the second sidelink control information, the RSRP threshold condition being met comprises: a sidelink reference signal received power (SL-RSRP) of a physical sidelink control channel (PSSCH) scheduled by the second sidelink control information being greater than or equal to a second RSRP threshold, wherein the second RSRP threshold is determined based on the priority indicated by the second sidelink control information and the priority of data transmission.

9. The method according to claim 1, wherein the priority indicated by the first sidelink control information or the second sidelink control information being higher than the priority of data transmission and/or higher than the priority threshold comprises:
in a case that sidelink control information meeting a first sub-condition is the first sidelink control information, the priority indicated by the first sidelink control information meeting the first sub-condition being higher than the priority of data transmission, or the priority indicated by the first sidelink control information meeting the first sub-condition being higher than the priority of data transmission and higher than a first priority threshold; or
in a case that sidelink control information meeting a first sub-condition is the second sidelink control information, the priority indicated by the second sidelink control information meeting the first sub-condition being higher than the priority of data transmission, or the priority indicated by the second sidelink control information meeting the first sub-condition being higher than the priority of data transmission and higher than a second priority threshold,
wherein the first sub-condition is that the second resource is overlapped with a resource determined based on the sidelink control information and the RSRP threshold condition is met;
wherein the first priority threshold is the same as the second priority threshold.

10. The method according to claim 1, wherein the first sidelink control information is sidelink control information in a new radio (NR) system, and the second sidelink control information is sidelink control information in a long-term evolution (LTE) system.

11. A terminal device, comprising: a processor and a memory storing one or more computer programs, wherein the processor, when loading and running the one or more computer programs, is caused to perform:
reselecting a first resource in a case that the first resource meets a first condition; wherein the first condition comprises at least one of the following items:
the first resource is not within a first resource set, wherein the first resource set is determined based on first sidelink control information and second sidelink control information;
a second resource determined based on the first resource is overlapped with a resource determined based on first sidelink control information or second sidelink control information, and a reference signal received power (RSRP) threshold condition is met; or
a priority indicated by first sidelink control information or second sidelink control information is higher than a priority of data transmission and/or higher than a priority threshold,
wherein the first sidelink control information is different from the second sidelink control information;
wherein the processor, when loading and running the one or more computer programs, is caused to perform: selecting a third resource from the first resource set to replace the first resource.

12. The terminal device according to claim 11, wherein
the first resource is a resource that the terminal device has selected but has not indicated by transmitting the first sidelink control information; or
the first resource is a resource that the terminal device has selected and has indicated by transmitting the first sidelink control information.

13. The terminal device according to claim 11, wherein the processor, when loading and running the one or more computer programs, is caused to further perform:
determining a resource selection window and a resource sensing window;
determining available resources within the resource selection window as an initialized resource set; and
acquiring the first resource set by excluding resources from the initialized resource set by a resource exclusion process, wherein the resource exclusion process comprises a first exclusion process and a second exclusion process, wherein the first exclusion process is used to exclude resources based on the first sidelink control information monitored within the resource sensing window, and the second exclusion process is used to exclude resources based on the second sidelink control information monitored within the resource sensing window;
wherein the resource exclusion process further comprises a third exclusion process, wherein the third exclusion process is used to exclude resources based on a non-monitored time unit within the resource sensing window;
wherein different RSRP threshold tables are configured for the first exclusion process and the second exclusion process.

14. The terminal device according to claim 11, wherein
the second resource is the first resource; or
the second resource comprises a series of resources that comprise the first resource, have a same frequency domain location as the first resource, and are spaced apart in time domain location.

15. The terminal device according to claim 11, wherein the resource determined based on the first sidelink control information comprises:
a resource indicated by the first sidelink control information monitored in a first time unit; or
resources indicated by the first sidelink control information monitored in a first time unit and by the first sidelink control information assumed to be received in Q1 time units corresponding to the first time unit, wherein the Q1 time units are determined based on the first time unit and a resource reservation period indicated in the first sidelink control information, and Q1 is a positive integer.

16. The terminal device according to claim 11, wherein the resource determined based on the second sidelink control information comprises: resources indicated by the second sidelink control information monitored in a second time unit and by the second sidelink control information assumed to be received in Q2 time units corresponding to the second time unit, wherein the Q2 time units are determined based on the second time unit and a resource reservation period indicated in the second sidelink control information, and Q2 is a positive integer.

17. The terminal device according to claim 11, wherein in a case that the second resource is overlapped with the resource determined based on the first sidelink control information, the RSRP threshold condition being met comprises: a sidelink reference signal received power (SL-RSRP) of a physical sidelink control channel (PSCCH) corresponding to the first sidelink control information or a physical sidelink shared channel (PSSCH) scheduled by the PSCCH being greater than or equal to a first RSRP threshold, wherein the first RSRP threshold is determined based on the priority indicated by the first sidelink control information and the priority of data transmission.

18. The terminal device according to claim 11, wherein in a case that the second resource is overlapped with the resource determined based on the second sidelink control information, the RSRP threshold condition being met comprises: a sidelink reference signal received power (SL-RSRP) of a physical sidelink control channel (PSSCH) scheduled by the second sidelink control information being greater than or equal to a second RSRP threshold, wherein the second RSRP threshold is determined based on the priority indicated by the second sidelink control information and the priority of data transmission.

19. The terminal device according to claim 11, wherein the priority indicated by the first sidelink control information or the second sidelink control information being higher than the priority of data transmission and/or higher than the priority threshold comprises:
in a case that sidelink control information meeting a first sub-condition is the first sidelink control information, the priority indicated by the first sidelink control information meeting the first sub-condition being higher than the priority of data transmission, or the priority indicated by the first sidelink control information meeting the first sub-condition being higher than the priority of data transmission and higher than a first priority threshold; or
in a case that sidelink control information meeting a first sub-condition is the second sidelink control information, the priority indicated by the second sidelink control information meeting the first sub-condition being higher than the priority of data transmission, or the priority indicated by the second sidelink control information meeting the first sub-condition being higher than the priority of data transmission and higher than a second priority threshold,
wherein the first sub-condition is that the second resource is overlapped with a resource determined based on the sidelink control information and the RSRP threshold condition is met;
wherein the first priority threshold is the same as the second priority threshold.

20. The terminal device according to claim 11, wherein the first sidelink control information is sidelink control information in a new radio (NR) system, and the second sidelink control information is sidelink control information in a long-term evolution (LTE) system.
